(19) United States
(12) Patent Application Publication
(10) Pub. No.: US 2010/0152455 A1
(43) Pub. Date: Jun. 17, 2010

(54) ORGANOMETALIC COMPOUNDS FOR ELECTROLUMINESCENCE AND ORGANIC ELECTROLUMINESCENT DEVICE USING THE SAME

(75) Inventors: Hyun Kim, Seoul (KR); Ho Joon Lee, Seoul (KR); Hyuck Joo Kwon, Seoul (KR); Young Jun Cho, Seoul (KR); Bong Ok Kim, Seoul (KR); Seung Soo Yoon, Seoul (KR)

Correspondence Address: ROHM AND HAAS ELECTRONIC MATERIALS LLC, 455 FOREST STREET, MARLBOROUGH, MA, 01752, US

(73) Assignee: Gracel Display Inc., Seoul (KR)

(21) Appl. No.: 12/448,714

(22) PCT Filed: Jan. 2, 2008
(86) PCT No.: PCT/KR2008/000008

§ 371 Date: Feb. 19, 2010

(30) Foreign Application Priority Data
Jan. 4, 2007 (KR) 10-2007-0000904

(51) Int. Cl. C07F 3/06

(52) U.S. Cl. 548/108

(57) ABSTRACT

The present invention relates to organic electroluminescent compounds and electroluminescent devices comprising the same as host material. The electroluminescent compounds according to the invention are characterized by having three ligands, two bivalent metals and a monovalent anion derived from an inorganic or an organic acid.

### TECHNICAL FIELD

The present invention relates to electroluminescent compounds consisting of metal complex exhibiting excellent electric conductivity and highly efficient electroluminescent properties, and electroluminescent devices using the same as host material.

### BACKGROUND ART

The most important factor to determine luminous efficiency in an OLED is the type of electroluminescent material. Though a fluorescent material has been widely used as an electroluminescent material up to the present, development of phosphorescent material is one of the best methods to improve luminous efficiency theoretically up to four (4) times, in view of electroluminescent mechanism. Up to now, iridium (III) complexes are widely known as phosphorescent material, including (acac)Ir(btp)2, Ir(ppy)3 and Firpic, as the red, green and blue one, respectively. In particular, a number of phosphorescent materials have been recently investigated in Japan, Europe and America.

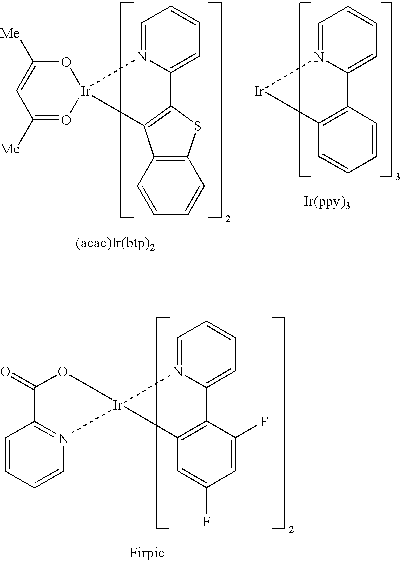

As a host material for phosphorescent light emitting material, CBP is most widely known up to the present, and OLEDs having high efficiency to which a hole blocking layer (such as BCP and BAlq) has been applied have been known. Pioneer (Japan) or the like reported OLEDs having high efficiency using a BAlq derivative as the host.

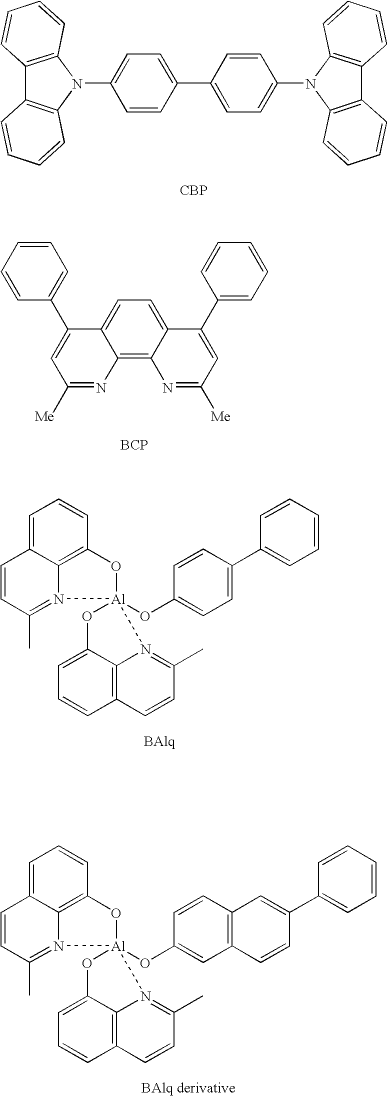

Though the materials in prior art are advantageous in view of light emitting property, they have low glass transition temperature and very poor thermal stability, so that the materials tend to be changed during high temperature vapor-deposition in vacuo. In an organic electroluminescent device (OLED), it is defined that power efficiency=(π/voltage)×current efficiency. Thus, the power efficiency is inversely proportional to the voltage, while the power efficiency should be higher in order to obtain lower power consumption of an OLED. In practice, an OLED employing phosphorescent electroluminescent (EL) material shows significantly higher current efficiency (cd/A) than an OLED employing fluorescent EL material. However, in case that a conventional material such as BAlq and CBP as host material of the phosphorescent EL material is employed, no significant advantage can be obtained in terms of power efficiency (lm/w) because of higher operating voltage as compared to an OLED employing a fluorescent material.

The present inventors invented EL compounds of the structures represented below, including the skeletal of a mixed-type ligand metal complex, which has far better EL properties and physical properties than those of conventional organic host materials or aluminum complexes; and filed as Korean Patent Application No. 2006-7467.

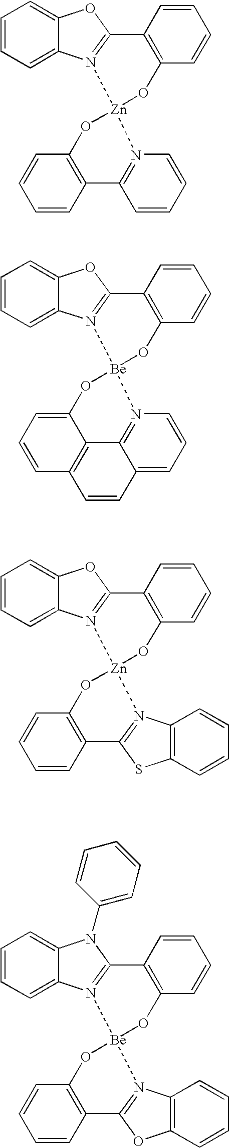

Conventional complexes of this type have been already investigated extensively since the middle of 1990's, as an EL material such as blue EL material. However, those materials have been simply applied as an EL material, with rare examples known to be applied as a host material for a phosphorescent EL material.

According to the present invention, developed was a metal complex material exhibiting excellent material stability, better electric conductivity and highly efficient EL properties as compared to conventional materials. A heteroatom included in an aromatic ring or in a side chain substituent having unpaired electron pair, has a high tendency of being coordinated with metal. Such a coordinate bond with very stable electrochemical property is a widely known property of the complex. By means of such a property, the present invention have developed various ligands, and prepared metal complexes, which were applied as host material.

### DISCLOSURE

### Technical Problem

The object of the present invention is to overcome the disadvantages as described above, and to provide EL compounds having the skeletal of a novel ligand metal complex to give more excellent electroluminescent properties and physical properties as compared to conventional organic host material or aluminum complexes. Another object of the present invention is to provide novel EL devices comprising the EL compounds thus prepared as host material.

### Technical Solution

The present invention relates to EL compounds represented by Chemical Formula (1), and EL devices comprising the EL compounds thus prepared as host material. The EL compound according to the present invention is characterized in that the compound consists of three ligands, two bivalent metals and a monovalent anion derived from an inorganic or an organic acid.

L¹L²L³M₂Q [Chemical Formula 1]

In the Formula, the ligands (L1, L2 and L3) are independently selected from the structures represented by following chemical structure; M is a bivalent metal; and Q is a monovalent anion derived from an inorganic or an organic acid.

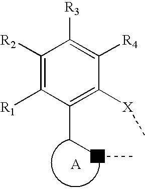

In the ligands, X is O, S or Se; ring A is oxazole, thiazole, imidazole, oxadiazole, thiadiazole, benzoxazole, benzothiazole, benzoimidazole, pyridine or quinoline; R1 through R4 independently represent hydrogen, C1-C5 alkyl, halogen, silyl group or C6-C20 aryl, or they may be bonded to an adjacent substituent via alkylene or alkenylene to form a fused ring; the pyridine and quinoline may chemically bonded to R1 to form a fused ring; and the ring A and aryl group of R1 through R7 may be further substituted by C1-C5 alkyl, halogen, C1-C5 alkyl having halogen substituent(s), phenyl, naphthyl, silyl or amino group.

Preferably, the ligands (L1, L2 and L3) are independently selected from one of the following chemical structures:

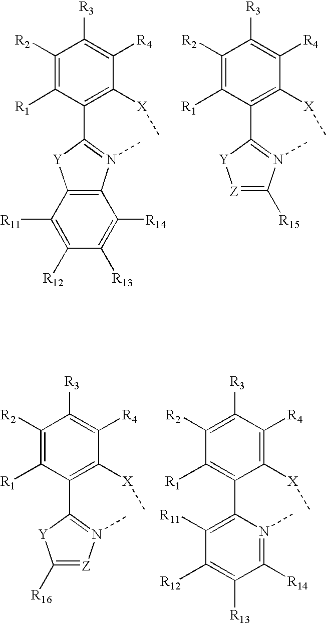

In the ligands, X and R1 through R4 are defined as in Chemical Formula (1); Y is O, S or NR21, Z is CH or N; R11 through R16 independently represent hydrogen, C1-C5 alkyl, halogen, C1-C5 alkyl having halogen substituent(s), phenyl, naphthyl, silyl or amino group, R11 through R14 may be bonded to an adjacent substituent via alkylene or alkenylene to form a fused ring, and R21 is C1-C5 alkyl, substituted or unsubstituted phenyl or naphthyl group.

In particular, the ligands (L1, L2 and L3) of the EL compounds according to the present invention may be identical, and selected from one of the following chemical structures:

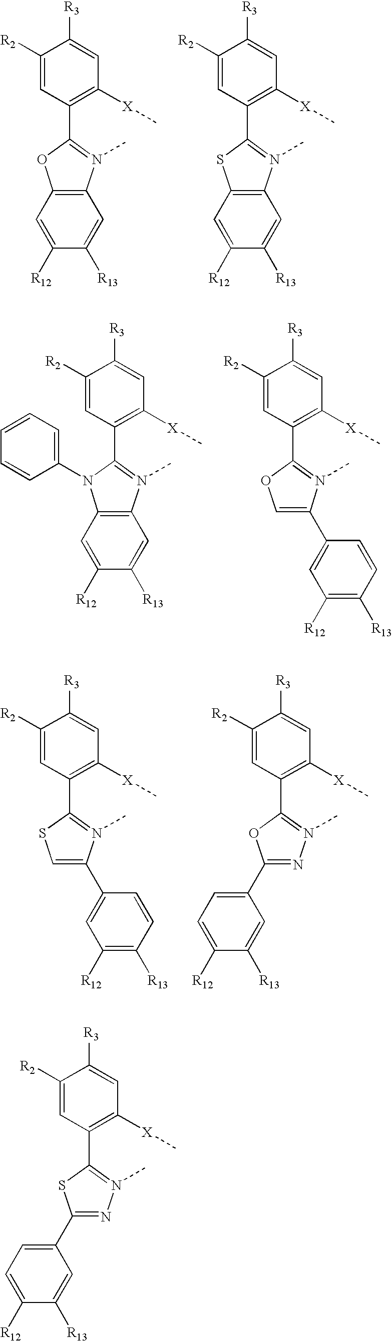

wherein, X is O, S or Se, and R2, R3, R12 and R13 independently represent hydrogen, methyl, ethyl, n-propyl, isopropyl, fluorine, chlorine, trifluoromethyl, phenyl, naphthyl, fluorenyl, trimethylsilyl, triphenylsilyl, t-butyldimethylsilyl, dimethylamine, diethylamine or diphenylamine; and the phenyl, naphthyl or fluorenyl may be further substituted by fluorine, chlorine, trimethylsilyl, triphenylsilyl, t-butyldimethylsilyl, dimethylamine, diethylamine or diphenylamine.

The electroluminescent compounds according to the present invention can be specifically exemplified by the compounds represented by one of the following compounds, but not being restricted thereto:

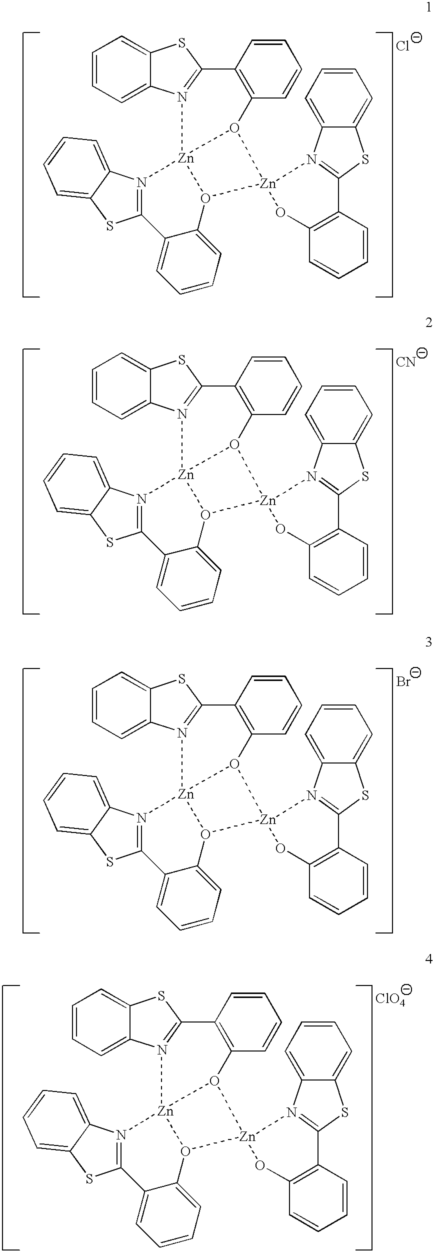

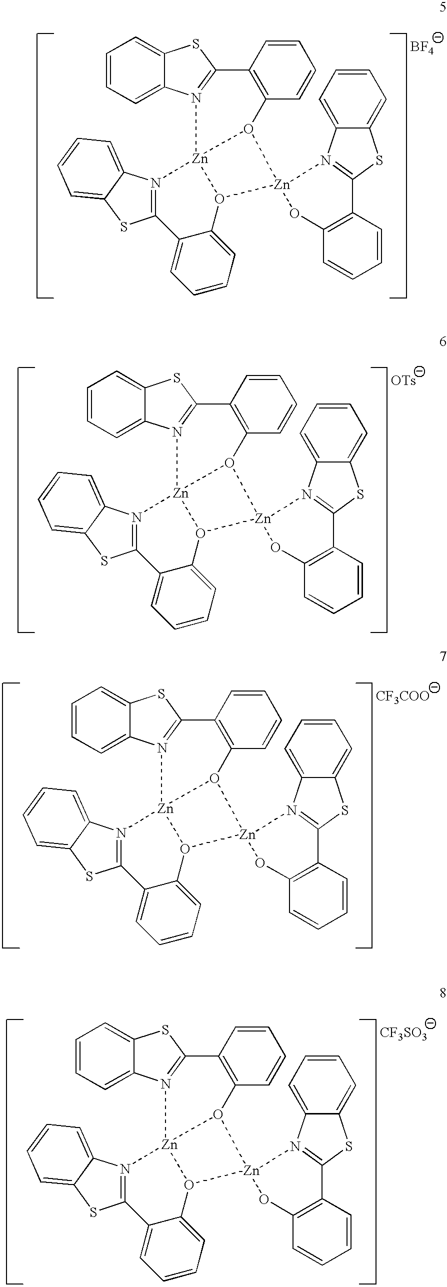

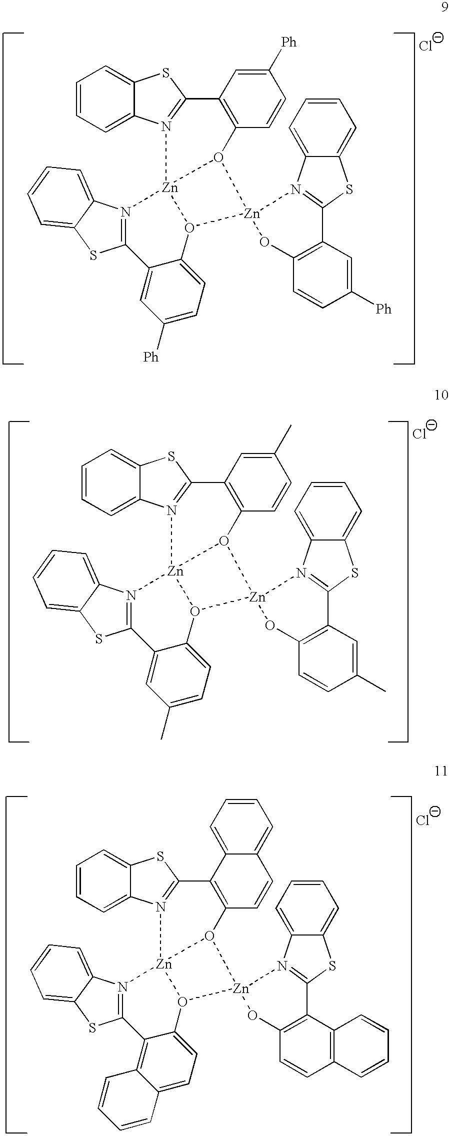

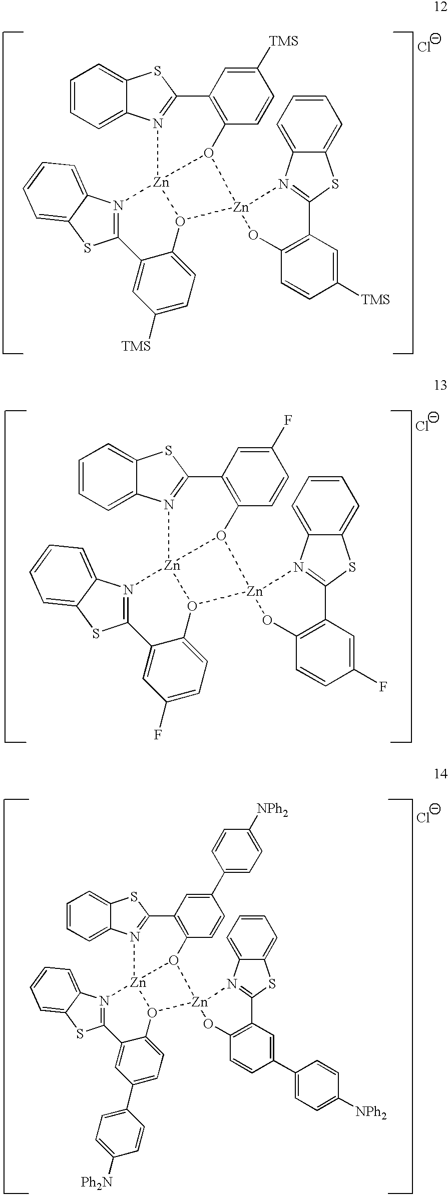

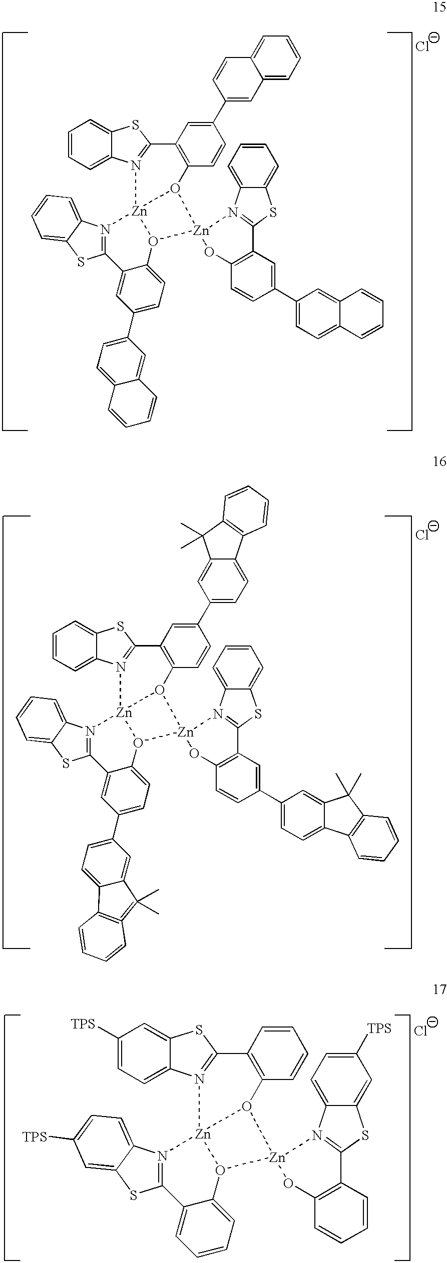

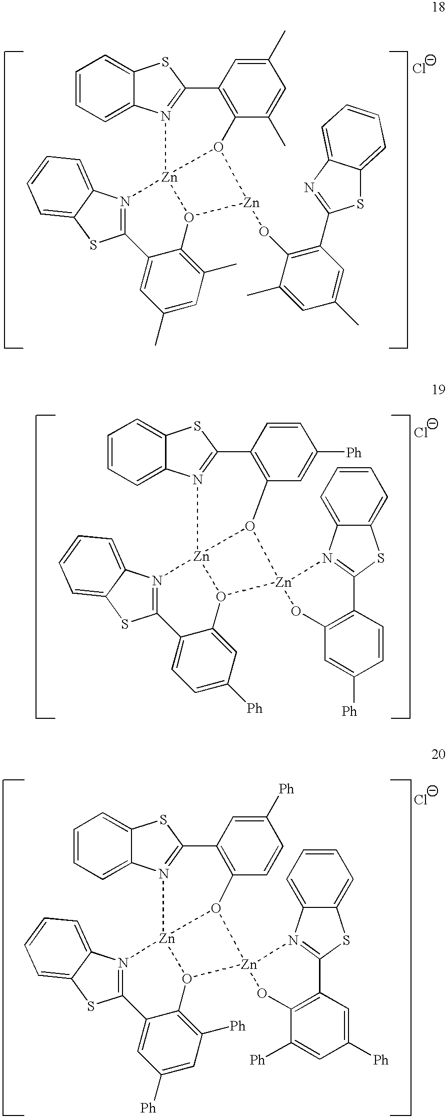

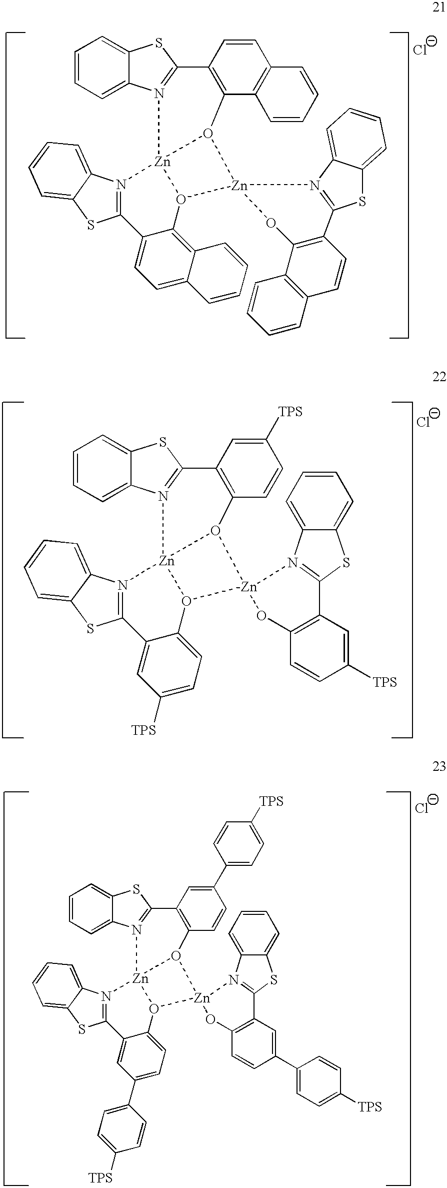

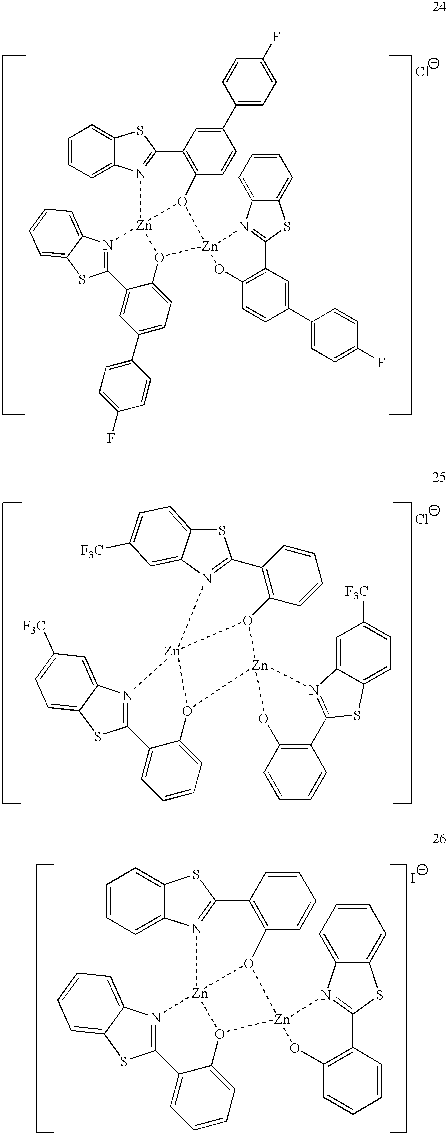

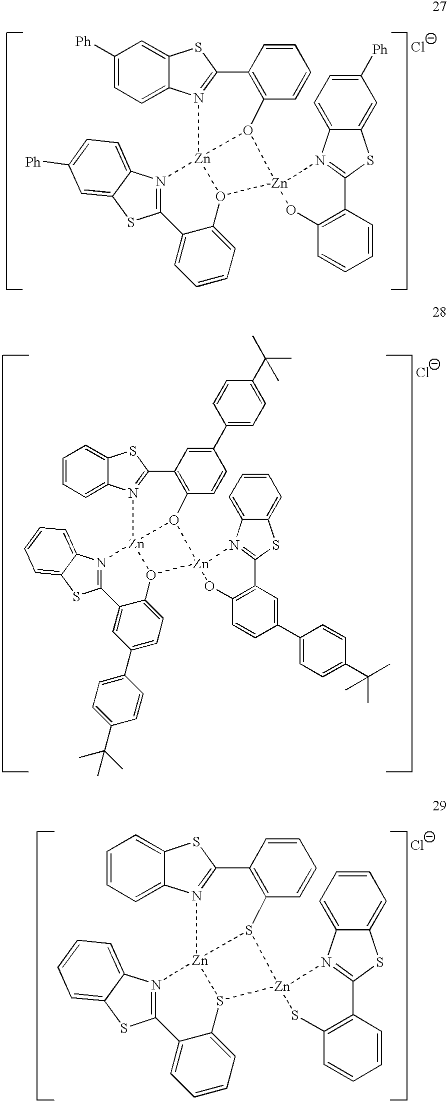

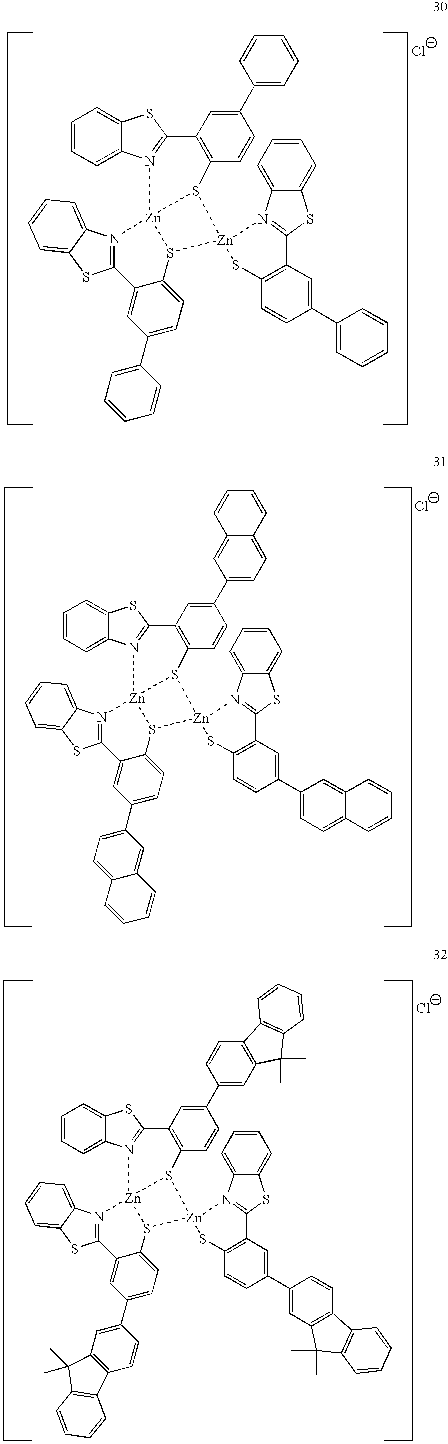

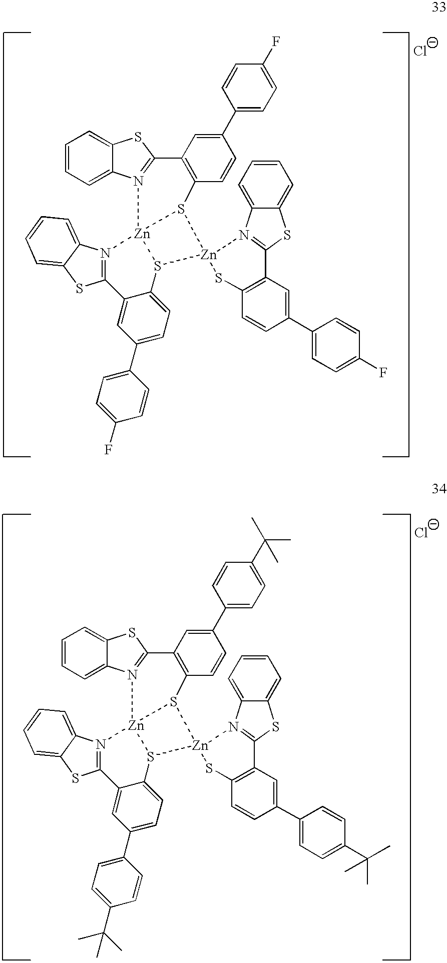

The electroluminescent device according to the present invention is characterized in that it employs the EL compound of the present invention as the host material for electroluminescent layer.

The EL compounds according to the present invention can be prepared by reacting the ligand with metal salt under basic aqueous condition in a molar ratio of 3:2.

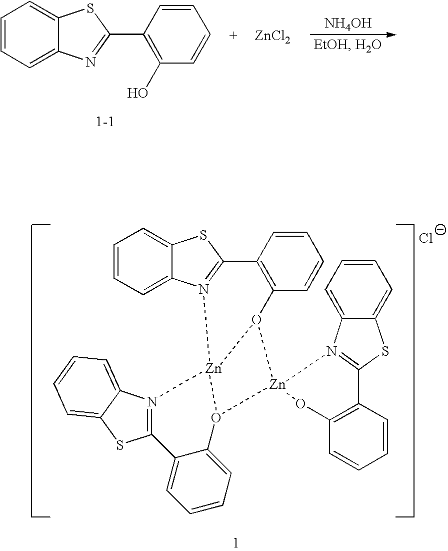

### BRIEF DESCRIPTION OF DRAWINGS

FIG. 1 is a cross-sectional view of an OLED device;

FIG. 2 shows voltage-luminance property of the OLED's manufactured according to Example 15 and Comparative Example 1;

FIG. 3 shows luminance-current efficiency of the OLED's manufactured according to Example 15 and Comparative Example 1;

FIG. 4 shows an EL spectrum of the OLED's manufactured according to Example 15 and Comparative Example 1.

### DESCRIPTION OF IMPORTANT PARTS OF THE DRAWINGS

1—glass
2—transparent electrode
3—a hole injection layer
4—a hole transportation layer
5—an electroluminescent layer
6—an electron transportation layer
7—an electron injection layer
8—Al cathode

### BEST MODE

### Preparation Examples

### Preparation Example 1

### Preparation of Compound (1)

In ethanol (1.2 L, 0.05 M), dissolved were 2-(2-hydroxyphenyl)benzothiazole (40.0 g, 176 mmol) and ZnCl₂ (16.0 g, 117.3 mmol), and the solution was stirred. To the solution, NH₄OH (20 mL, 235 mmol) was added dropwise, and the resultant mixture was stirred at 60° C. under reflux for 30 minutes. After cooling the mixture to room temperature, additional NH₄OH (20 mL) was added dropwise thereto, and the resultant mixture was stirred at room temperature for 12 hours. Water (400 mL) was then added, and the mixture was stirred for 6 hours, washed with water (1 L), EtOH (1.5 L) and hexane (500 mL), filtered and dried to obtain Compound (1) (35 g, 43.2 mmol, 74%).

mp. >300° C.

¹H NMR (300 MHz, CDCl₃): d=8.23-8.12 (m, 2H), 7.55 (m, 2H), 7.31 (d, J=7.7 Hz, 1H), 7.05 (t, J=7.4 Hz, 1H), 6.88 (t, J=7.7 Hz, 1H), 6.79 (d, J=7.2 Hz, 1H)

MS/FAB: 805.96 (found), 809.6 (calculated)

### Preparation Example 2

### Preparation of Compound (2)

In ethanol (100 mL, 0.07 M), dissolved were 2-(2-hydroxyphenyl)benzothiazole (5 g, 22 mmol) and ZnCN₂ (1.7 g, 14.6 mmol), and the solution was stirred at room temperature for 30 minutes. Then, NH₄OH (2.89 mL) was slowly added and the resultant mixture was stirred for 12 hours, and then washed with water (300 mL), EtOH (300 mL) and hexane (200 mL). Filtration and drying gave Compound (2) (2.0 g, 2.5 mmol, 34%).

mp. >300° C.

¹H NMR (300 MHz, CDCl₃): d=8.22-8.12 (m, 2H), 7.56 (m, 2H), 7.30 (d, J=7.7 Hz, 1H), 7.05 (t, J=7.2 Hz, 1H), 6.88 (t, J=7.7 Hz, 1H), 6.80 (d, J=7.2 Hz, 1H),

MS/FAB: 805.96 (found), 809.6 (calculated)

### Preparation Example 3

### Preparation of Compound (3)

Compound (3) (1.8 g, 2.2 mmol, 75%) was obtained by repeating the same procedure as described in Preparation Example 1, but using 2-(2-hydroxyphenyl)benzothiazole (2.0 g, 8.8 mmol), ZnBr₂H₂O (1.54 g, 5.9 mmol), EtOH (100 mL, 0.03 M), NH₄OH (2.0 mL) and water (20 mL).

mp. >300° C.

¹H NMR (300 MHz, CDCl₃): d=8.22-8.12 (m, 2H), 7.55 (m, 2H), 7.31 (d, J=7.7 Hz, 1H), 7.04 (t, J=7.2 Hz, 1H), 6.88 (t, J=7.6 Hz, 1H), 6.81 (d, J=7.2 Hz, 1H)

MS/FAB: 805.96 (found), 809.6 (calculated)

### Preparation Example 4

### Preparation of Compound (4)

Compound (4) (1.6 g, 2.0 mmol, 60%) was obtained by repeating the same procedure as described in Preparation Example 1, but using 2-(2-hydroxyphenyl)benzothiazole (2.0 g, 8.8 mmol), ZnClO₄. 6H₂O (2.2 g, 5.9 mmol), EtOH (100 mL, 0.03 M), NH₄OH (2.0 mL) and water (20 mL).

mp. >300° C.

¹H NMR (300 MHz, CDCl₃): d=8.22-8.12 (m, 2H), 7.55 (m, 2H), 7.31 (d, J=7.7 Hz, 1H), 7.05 (t, J=7.2 Hz, 1H), 6.89 (t, J=7.6 Hz, 1H), 6.79 (d, J=7.2 Hz, 1H)

MS/FAB: 805.96 (found), 809.6 (calculated)

### Preparation Example 5

### Preparation of Compound (5)

Compound (5) (1.6 g, 2.0 mmol, 60%) was obtained by repeating the same procedure as described in Preparation Example 1, but using 2-(2-hydroxyphenyl)benzothiazole (2.0 g, 8.8 mmol), Zn(BF₄)₂ (1.4 g, 5.9 mmol), EtOH (100 mL, 0.03 M), NH₄OH (2.0 mL) and water (20 mL).

mp. >300° C.

¹H NMR (300 MHz, CDCl₃): d=8.23-8.12 (m, 2H), 7.55 (m, 2H), 7.31 (d, J=7.7 Hz, 1H), 7.01 (t, J=7.2 Hz, 1H), 6.89 (t, J=7.7 Hz, 1H), 6.79 (d, J=7.2 Hz, 1H)

MS/FAB: 805.96 (found), 809.6 (calculated)

### Preparation Example 6

### Preparation of Compound (6)

Compound (6) (1.2 g, 1.5 mmol, 42%) was obtained by repeating the same procedure as described in Preparation Example 1, but using 2-(2-hydroxyphenyl)benzothiazole (2.0 g, 8.8 mmol), Zn(p-OTs)₂ (2.4 g, 5.9 mmol), EtOH (100 mL, 0.03 M), NH₄OH (2.0 mL) and water (20 mL).

mp. >300° C.

¹H NMR (300 MHz, CDCl₃): d=8.23-8.12 (m, 2H), 7.55 (m, 2H), 7.31 (d, J=7.7 Hz, 1H), 7.05 (t, J=7.2 Hz, 1H), 6.88 (t, J=7.7 Hz, 1H), 6.79 (d, J=7.2 Hz, 1H)

MS/FAB: 805.96 (found), 809.6 (calculated)

### Preparation Example 7

### Preparation of Compound (7)

Compound (7) (1.3 g, 1.6 mmol, 42%) was obtained by repeating the same procedure as described in Preparation Example 1, but using 2-(2-hydroxyphenyl)benzothiazole (2.0 g, 8.8 mmol), Zn(CF₃COO)₂ (1.3 g, 5.9 mmol), EtOH (100 mL, 0.03 M), NH₄OH (2.0 mL) and water (20 mL).

mp. >300° C.

¹H NMR (300 MHz, CDCl₃): d=8.22-8.12 (m, 2H), 7.55 (m, 2H), 7.31 (d, J=7.7 Hz, 1H), 7.05 (t, J=7.2 Hz, 1H), 6.88 (t, J=7.4 Hz, 1H), 6.79 (d, J=7.2 Hz, 1H)

MS/FAB: 805.96 (found), 809.6 (calculated)

### Preparation Example 8

### Preparation of Compound (8)

Compound (8) (2 g, 2.5 mmol, 85%) was obtained by repeating the same procedure as described in Preparation Example 1, but using 2-(2-hydroxyphenyl)benzothiazole (2.0 g, 8.8 mmol), Zn(CF₃SO₃)₂ (2.1 g, 5.9 mmol), EtOH (100 mL, 0.03 M), NH₄OH (2.0 mL) and water (20 mL).

mp. >300° C.

¹H NMR (300 MHz, CDCl₃): d=8.23-8.12 (m, 2H), 7.55 (m, 2H), 7.31 (d, J=7.7 Hz, 1H), 7.05 (t, J=7.2 Hz, 1H), 6.88 (t, J=7.7 Hz, 1H), 6.79 (d, J=7.2 Hz, 1H)

MS/FAB: 805.96 (found), 809.6 (calculated)

### Preparation Example 9

### Preparation of Compound (9)

In dimethoxyethane (DME) (200 mL, 0.5 M) and H₂O (66 mL), dissolved were 5-bromosalicylaldehyde (20 g, 99.5 mmol) and phenylboronic acid (13.4 g, 109.5 mmol), and the solution was stirred. To the solution, added were Pd(PPh₃)₄ (5.8 g, 5.0 mmol) and aqueous 2M K₂CO₃ solution (66 mL), and the mixture was stirred at 90° C. under reflux for 4 hours. After quenching with water (100 mL), the reaction mixture was washed, and extracted with ethylacetate (EA) (200 mL). Drying under reduced pressure and purification via silica gel column chromatography (n-hexane: methylene chloride (MC)=1:5) gave 5-phenylsalicylaldehyde (12 g, 61 mmol, 61%).

The compound, 5-phenylsalicylaldehyde (5.0 g, 25.2 mmol) thus obtained and 2-aminobenzenethiol (3.8 g, 30.2 mmol) were dissolved in 1,4-dioxane (12 mL, 2.1 M), and the solution was stirred at 100° C. under pressure for 12 hours. After cooling to room temperature, the reaction mixture was extracted with MC (100 mL), washed with water (100 mL) and dried under reduced pressure. Purification via silica gel column chromatography (n-hexane: MC=3:1) gave 2-(benzo[d]thiazol-2-yl)-4-phenylphenol (4.5 g, 14.8 mmol, 59%).

Compound (9) (2 g, 2.5 mmol, 85%) was obtained by repeating the same procedure as described in Preparation Example 1, but using 2-(benzo[d]thiazol-2-yl)-4-phenylphenol (2.0 g, 6.6 mmol), ZnCl₂ (600 mg, 4.4 mmol), EtOH (100 mL, 0.02 M), NH₄OH (2.0 mL) and water (20 mL).

mp. >300° C.

¹H NMR (300 MHz, CDCl₃): d=8.23-8.12 (m, 2H), 7.55 (m, 2H), 7.53 (s, 1H), 7.48 (d, J=7.3 Hz, 2H), 7.32 (m, 2H), 7.27 (d, J=7.1 Hz, 1H), 7.27 (t, J=6.2 Hz, 1H), 6.85 (d, J=7.3 Hz, 1H)

MS/FAB: 1034.05 (found), 1037.89 (calculated)

### Preparation Example 10

### Preparation of Compound (10)

The compound, 2-aminobenzenethiol (5.3 g, 42.4 mmol) and 5-methylsalicylaldehyde (4.8 g, 35.3 mmol) were dissolved in 1,4-dioxane (12 mL, 2.1 M), and the solution was stirred at 100° C. under pressure for 12 hours. After cooling to room temperature, the reaction mixture was extracted with MC (100 mL), washed with water (100 mL) and dried under reduced pressure. Purification via silica gel column chromatography (n-hexane: MC=3:1) gave 2-(benzo[d]thiazol-2-yl)-4-methylphenol (3.1 g, 13.0 mmol, 37%).

Compound (10) (2 g, 2.35 mmol, 84%) was obtained by repeating the same procedure as described in Preparation Example 1, but using 2-(benzo[d]thiazol-2-yl)-4-methylphenol (2.0 g, 8.3 mmol) thus obtained, ZnCl₂ (750 mg, 5.5 mmol), EtOH (130 mL, 0.02 M), NH₄OH (2.0 mL) and water (20 mL).

mp. >300° C.

¹H NMR (300 MHz, CDCl₃): d=8.23-8.12 (m, 2H), 7.55 (m, 2H), 7.11 (s, 1H), 6.75 (m, 2H), 2.35 (s, 1H)

MS/FAB: 848.0 (found), 851.68 (calculated)

### Preparation Example 11

### Preparation of Compound (11)

The compound, 2-aminobenzenethiol (7.27 g, 58.08 mmol) and 2-hydroxy-1-naphthaldehyde (10 g, 58.08 mmol) were dissolved in 1,4-dioxane (20 mL, 2.9 M), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 1-(benzo[d]thiazol-2-yl)-4-naphthalen-2-ol (10 g, 36.1 mmol, 62%).

Compound (11) (1.5 g, 1.6 mmol, 66%) was obtained by repeating the same procedure as described in Preparation Example 1, but using 1-(benzo[d]thiazol-2-yl)naphthalen-2-ol (2.0 g, 7.2 mmol) thus obtained, ZnCl₂ (654 mg, 4.8 mmol), EtOH (120 mL, 0.02 M), NH₄OH (2.0 mL) and water (20 mL).

mp. >300° C.

¹H NMR (300 MHz, CDCl₃): d=8.21-8.12 (m, 2H), 7.60-7.48 (m, 5H), 7.31-7.2 (m, 2H), 7.0 (d, J=7.2 Hz, 1H)

MS/FAB: 956 (found), 959.78 (calculated)

### Preparation Example 12

### Preparation of Compound (12)

In 1,4-dioxane (50 mL, 4.0 M), dissolved were 2-aminobenzenethiol (24.8 g, 198 mmol) and 5-bromosalicylaldehyde (40 g, 198 mmol), and the solution was stirred at 100° C. under pressure for 12 hours. After cooling to room temperature, the reaction mixture was extracted with MC (300 mL), washed with water (200 mL) and dried under reduced pressure. Purification via silica gel column chromatography (n-hexane: MC=2:1) gave 2-(benzo[d]thiazol-2-yl)-4-bromophenol (34 g, 118.4 mmol, 60%).

Under argon atmosphere, 2-(benzo[d]thiazol-2-yl)-4-bromophenol (4 g, 13.1 mmol) was dissolved in THF (50 mL, 0.03 M), and the solution was cooled to −78° C. To the solution, n-BuLi (2.5 M in hexane, 7.9 mL, 19.7 mmol) was added dropwise, and the mixture was stirred for 30 minutes. Trimethylsilylchloride (TMSCl) (1.4 g, 13.1 mmol) dissolved in THF (25 mL, 0.5 M) was slowly added thereto, and the reaction mixture was stirred for 12 hours while slowly raising the temperature to room temperature. After quenching with water (100 mL), the reaction mixture was extracted with MC (50 mL). Drying under reduced pressure and purification via silica gel column chromatography (n-hexane: MC=3:1) gave 2-(benzo[d]thiazol-2-yl)-4-trimethylsilylphenol (3 g, 10.1 mmol, 62%).

Compound (12) (1.3 g, 1.3 mmol, 58%) was obtained by repeating the same procedure as described in Preparation Example 1, but using 2-(benzo[d]thiazol-2-yl)-4-trimethylsilylphenol (2.0 g, 6.7 mmol) thus obtained, ZnCl₂ (613 mg, 4.5 mmol), EtOH (110 mL, 0.02 M), NH₄OH (2.0 mL) and water (20 mL).

mp. >300° C.

¹H NMR (300 MHz, CDCl₃): d=8.22-8.12 (m, 2H), 7.55-7.27 (m, 4H), 6.77 (d, J=7.2 Hz, 1H)

MS/FAB: 1022 (found), 1026.15 (calculated)

### Preparation Example 13

### Preparation of Compound (13)

In 1,4-dioxane (30 mL, 2.1 M), dissolved were 2-aminobenzenethiol (8.9 g, 71.4 mmol) and 5-fluorosalicylaldehyde (10 g, 71.4 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 2-(benzo[d]thiazol-2-yl)-4-fluorophenol (7 g, 50.0 mmol, 70%).

Compound (13) (1.8 g, 2.1 mmol, 44%) was obtained by repeating the same procedure as described in Preparation Example 1, but using 2-(benzo[d]thiazol-2-yl)-4-fluorophenol (2.0 g, 14.3 mmol) thus obtained, ZnCl₂ (1.3 g, 9.5 mmol), EtOH (200 mL, 0.02 M), NH₄OH (2.0 mL) and water (20 mL).

mp. >300° C.

¹H NMR (300 MHz, CDCl₃): d=8.23-8.12 (m, 2H), 7.55 (m, 2H), 7.02 (s, 1H), 6.77-6.70 (m, 2H)

MS/FAB: 860 (found), 863.58 (calculated)

### Preparation Example 14

### Preparation of Compound (14)

In 1,4-dioxane (50 mL, 4.0 M), dissolved were 2-aminobenzenethiol (24.8 g, 198 mmol) and 5-bromosalicylaldehyde (40 g, 198 mmol), and the solution was stirred at 100° C. under pressure for 12 hours. After cooling to room temperature, the reaction mixture was extracted with MC (300 mL), washed with water (200 mL) and dried under reduced pressure. Purification via silica gel column chromatography (n-hexane: MC=2:1) gave 2-(benzo[d]thiazol-2-yl)-4-bromophenol (34 g, 118.4 mmol, 60%).

The compound, 2-(benzo[d]thiazol-2-yl)-4-bromophenol (5 g, 16.33 mmol) thus obtained and 4-bromophenylboronic acid (3.94 g, 19.6 mmol) were dissolved in toluene (40 mL), EtOH (27 mL) and H₂O (13 mL), and the solution was stirred. To the solution, added were PdCl₂(PPh₃)₂ (573 mg, 0.82 mmol) and K₂CO₃ (4.51 g, 32.66 mmol), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:4) gave 2-(benzo[d]thiazol-2-yl)-4-(4-bromophenyl)phenol (5.5 g, 14.5 mmol, 89%).

The compound, 2-(Benzo[d]thiazol-2-yl)-4-(4-bromophenyl)phenol (3 g, 7.89 mmol) thus obtained and diphenylamine (1.47 g, 8.68 mmol) were dissolved in toluene (30 mL), and the solution was stirred. To the solution, added were Pd(OAc)₂ (1.33 g, 0.006 mmol), t-BuONa (1.14 g, 11.8 mmol), P(t-BuO)₃ (4.79 mg, 0.024 mmol), and the mixture was stirred at 100° C. under reflux for 6 hours. After quenching with water (100 mL) and washing, the reaction mixture was extracted with EA (100 mL). Drying under reduced pressure and purification via silica gel column chromatography (n-hexane: MC=1:2) gave 2-(benzo[d]thiazol-2-yl)-4-(4-diphenylaminophenyl)phenol (2.9 g, 6.2 mmol, 79%).

Compound (14) (1.7 g, 1.1 mmol, 79%) was obtained by repeating the same procedure as described in Preparation Example 1, but using 2-(benzo[d]thiazol-2-yl)-4-(4-diphenylaminophenyl)phenol (2.0 g, 4.25 mmol) thus obtained, ZnCl₂ (386 mg, 2.83 mmol), EtOH (200 mL, 0.02 M), NH₄OH (2.0 mL) and water (20 mL).

mp. >300° C.

¹H NMR (300 MHz, CDCl₃): d=8.23-8.12 (m, 2H), 7.55-7.02 (m, 10H), 6.85-6.46 (m, 8H)

MS/FAB: 1535.27 (found), 1539.51 (calculated)

### Preparation Example 15

### Preparation of Compound (15)

The compound, 5-bromosalicylaldehyde (20 g, 99.5 mmol) and 2-naphthyl boronic acid (18.8 g, 109.5 mmol) were dissolved in toluene (300 mL), and the solution was stirred. To the solution, added were Pd(PPh₃)₄ (5.8 g, 4.98 mmol) and 2M K₂CO₃ (100 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:5) gave 5-(2-naphthyl)salicylaldehyde (14.4 g, 58 mmol, 58.3%).

In 1,4-dioxane (7 mL, 2.1 M), dissolved were 5-(2-naphtyl)salicylaldehyde (3.0 g, 12.1 mmol) and 2-aminobenzenethiol (1.8 g, 14.5 mmol), and the solution was stirred at 100° C. under pressure for 12 hours. After cooling to room temperature, the reaction mixture was extracted with MC (100 mL), washed with water (100 mL) and dried under reduced pressure. Purification via silica gel column chromatography (n-hexane: MC=3:1) gave 2-(benzo[d]thiazol-2-yl)-4-(2-naphthyl)phenol (2.8 g, 7.92 mmol, 65%).

Compound (15) (1.2 g, 1.01 mmol, 53%) was obtained by repeating the same procedure as described in Preparation Example 1, but using 2-(benzo[d]thiazol-2-yl)-4-(2-naphthyl)phenol (2.0 g, 5.7 mmol) thus obtained, ZnCl₂ (518 mg, 3.8 mmol), EtOH (100 mL, 0.02 M), NH₄OH (2.0 mL) and water (20 mL).

mp. >300° C.

¹H NMR (300 MHz, CDCl₃): d=8.23-8.12 (m, 2H), 7.9-7.53 (m, 8H), 7.3-7.2 (m, 3H), 6.85 (d, J=5.5 Hz, 1H)

MS/FAB: 1184.1 (found), 1188.07 (calculated)

### Preparation Example 16

### Preparation of Compound (16)

The compound, 5-bromosalicylaldehyde (20 g, 99.5 mmol) and 9,9-dimethyl-9H-fluoren-2-yl-2-boronic acid (26.1 g, 109.5 mmol) were dissolved in toluene (300 mL, 0.33 M), and the solution was stirred. To the solution, added were Pd(PPh₃)₄ (5.8 g, 4.98 mmol) and 2M K₂CO₃ (100 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:5) gave 5-(9,9-dimethyl-9H-fluoren-2-yl)salicylaldehyde (19.2 g, 61 mmol, 61.3%).

In 1,4-dioxane (7 mL, 2.1 M), dissolved were 5-(9,9-dimethyl-9H-fluoren-2-yl)salicylaldehyde (3.8 g, 12.1 mmol) thus obtained and 2-aminobenzenethiol (1.8 g, 14.5 mmol), and the solution was stirred at 100° C. under pressure for 12 hours. After cooling to room temperature, the reaction mixture was extracted with MC (100 mL), washed with water (100 mL) and dried under reduced pressure. Purification via silica gel column chromatography (n-hexane: MC=3:1) gave 2-(benzo[d]thiazol-2-yl)-4-(9,9-dimethyl-9H-fluoren-2-yl)phenol (2.1 g, 5.01 mmol, 41%).

Compound (16) (1.0 g, 0.72 mmol, 45%) was obtained by repeating the same procedure as described in Preparation Example 1, but using 2-(benzo[d]thiazol-2-yl)-4-(9,9-dimethyl-9H-fluoren-2-yl)phenol (2.0 g, 4.8 mmol) thus obtained, ZnCl₂ (436 mg, 3.2 mmol), EtOH (80 mL, 0.02 M), NH₄OH (2.0 mL) and water (20 mL).

mp. >300° C.

¹H NMR (300 MHz, CDCl₃): d=8.23-8.12 (m, 2H), 7.9-7.53 (m, 8H), 7.38-7.0 (m, 4H), 1.67 (s, 6H)

MS/FAB: 1382.24 (found), 1386.37 (calculated)

### Preparation Example 17

### Preparation of Compound (17)

Under argon atmosphere, 2-amino-6-bromobenzothiazole (20 g, 87.3 mmol) and 10 N KOH (100 mL) were added to ethylene glycol (20 mL), and the mixture was stirred at 125° C. under reflux for 15 hours. After cooling to room temperature, 12 N HCl (30 mL) was added to the reaction mixture to quench the reaction. The reaction mixture was then washed with water (100 mL) and extracted with EA (100 mL). Recrystallization from MeOH (200 mL) gave 2-amino-5-bromobenzenethiol (14 g, 68.6 mmol, 79%).

In 1,4-dioxane (35 mL, 2.0 M), dissolved were 2-amino-5-bromobenzenethiol (14 g, 68.6 mmol) and salicylaldehyde (7.0 g, 57.2 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=5:2) gave 2-(6-bromobenzo[d]thiazol-2-yl) phenol (15.5 g, 50.5 mmol, 88.3%).

Under argon atmosphere, 2-(6-bromobenzo[d]thiazol-2-yl)phenol (15.5 g, 50.5 mmol) was dissolved in THF (160 mL, 0.3 M), and the solution was cooled to −78° C. To the solution, t-BuLi (1.7 M in hexane, 44.6 mL, 75.8 mmol) was added dropwise, and the mixture was stirred for 30 minutes. Triphenylsilyl chloride (TPSCl) (22.3 g, 75.8 mmol) dissolved in THF (50 mL) was slowly added thereto. The reaction mixture was stirred for 12 hours while slowly raising the temperature to room temperature. After quenching the reaction by adding water (100 mL), the reaction mixture was extracted with MC (80 mL). Drying under reduced pressure and purification via silica gel column chromatography (n-hexane: MC=3:1) gave 2-(6-triphenylsilylbenzo[d]thiazol-2-yl)phenol (20.4 g, 42 mmol, 83%).

Compound (17) (1.0 g, 0.72 mmol, 45%) was obtained by repeating the same procedure as described in Preparation Example 1, but using 2-(6-triphenylsilylbenzo[d]thiazol-2-yl)phenol (2.0 g, 4.1 mmol), ZnCl₂ (375 mg, 2.7 mmol), EtOH (70 mL, 0.02 M), NH₄OH (2.0 mL) and water (20 mL).

mp. >300° C.

¹H NMR (300 MHz, CDCl₃): d=8.40-8.34 (m, 2H), 7.83-7.55 (m, 7H), 7.35 (s, 9H), 7.31 (d, J=5.1 Hz, 1H), 7.0-6.7 (m, 3H)

MS/FAB: 1580.22 (found), 1584.77 (calculated)

### Preparation Example 18

### Preparation of Compound (18)

In 1,4-dioxane (7 mL, 2.1 M), dissolved were 2-aminobenzenethiol (1.8 g, 14.5 mmol) and 3,5-dimethyl salicylaldehyde (1.64 g, 12.1 mmol), and the solution was stirred at 100° C. under pressure for 12 hours. After cooling to room temperature, the reaction mixture was extracted with MC (50 mL), washed with water (30 mL) and dried under reduced pressure. Purification via silica gel column chromatography (n-hexane: MC=3:1) gave 2-(benzo[d]thiazol-2-yl)-4,6-dimethylphenol (2.3 g, 9.2 mmol, 76%).

Compound (18) (1.3 g, 1.5 mmol, 58%) was obtained by repeating the same procedure as described in Preparation Example 1, but using 2-(benzo[d]thiazol-2-yl)-4,6-dimethylphenol (2.0 g, 7.8 mmol), ZnCl₂ (709 mg, 5.2 mmol), EtOH (120 mL, 0.02 M), NH₄OH (2.0 mL) and water (20 mL).

mp. >300° C.

¹H NMR (300 MHz, CDCl₃): d=8.23-8.12 (m, 2H), 7.53 (m, 2H), 6.92 (s, 1H), 6.65 (s, 1H), 4.6 (s, 1H)

MS/FAB: 1580.22 (found), 1584.77 (calculated)

### Preparation Example 19

### Preparation of Compound (19)

The compound, 4-bromosalicylaldehyde (20 g, 99.5 mmol) and phenylboronic acid (26.1 g, 109.5 mmol) were dissolved in toluene (300 mL, 0.33 M), and the solution was stirred. To the solution, added were Pd(PPh₃)₄ (5.8 g, 4.98 mmol) and 2M K₂CO₃ (100 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:5) gave 4-phenyl salicylaldehyde (18.2 g, 60 mmol, 60%).

In 1,4-dioxane (7 mL, 2.1 M), dissolved were 2-aminobenzenethiol (1.8 g, 14.5 mmol) and 4-phenyl salicylaldehyde (1.64 g, 12.1 mmol), and the solution was stirred at 100° C. under pressure for 12 hours. After cooling to room temperature, the reaction mixture was extracted with MC (50 mL), washed with water (30 mL) and dried under reduced pressure. Purification via silica gel column chromatography (n-hexane: MC=3:1) gave 2-(benzo[d]thiazol-2-yl)-5-phenylphenol (2.3 g, 9.2 mmol, 76%).

Compound (19) (1.3 g, 1.5 mmol, 58%) was obtained by repeating the same procedure as described in Preparation Example 1, but using 2-(benzo[d]thiazol-2-yl)-5-phenylphenol (2.0 g, 7.8 mmol), ZnCl₂ (709 mg, 5.2 mmol), EtOH (120 mL, 0.02 M), NH₄OH (2.0 mL) and water (20 mL).

mp. >300° C.

¹H NMR (300 MHz, CDCl₃): d=8.21-8.10 (m, 2H), 7.55-7.32 (m, 7H), 7.22-7.10 (m, 2H), 7.01 (d, J=5.3 Hz, 1H)

MS/FAB: 1034.1 (found), 1037.89 (calculated)

### Preparation Example 20

### Preparation of Compound (20)

The compound, 3,5-dibromosalicylaldehyde (20 g, 71.5 mmol) and phenylboronic acid (13.1 g, 107.3 mmol) were dissolved in toluene (250 mL, 0.29 M), and the solution was stirred. To the solution, added were Pd(PPh₃)₄ (2.5 g, 2.15 mmol) and 2M K₂CO₃ (83 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:5) gave 3,5-diphenyl salicylaldehyde (15.9 g, 58 mmol, 81%).

In 1,4-dioxane (28 mL, 2.1 M), dissolved were 2-aminobenzenethiol (8.7 g, 69.6 mmol) and 3,5-diphenyl salicylaldehyde (15.9 g, 58 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 2-(benzo[d]thiazol-2-yl)-4,6-diphenylphenol (17.1 g, 45 mmol, 78%).

Compound (20) (1.3 g, 1.0 mmol, 57%) was obtained by repeating the same procedure as described in Preparation Example 1, but using 2-(benzo[d]thiazol-2-yl)-4,6-diphenylphenol (2.0 g, 5.3 mmol), ZnCl₂ (477.1 mg, 3.5 mmol), EtOH (85 mL, 0.02 M), NH₄OH (2.0 mL) and water (20 mL).

mp. >300° C.

¹H NMR (300 MHz, CDCl₃): d=8.23-8.11 (m, 2H), 7.55-7.48 (m, 8H), 7.35-7.31 (m, 3H), 7.23-7.2 (m, 2H)

MS/FAB: 1262.14 (found), 1266.18 (calculated)

### Preparation Example 21

### Preparation of Compound (21)

In 1,4-dioxane (28 mL, 2.1 M), dissolved were 2-aminobenzenethiol (8.7 g, 69.6 mmol) and 1-hydroxy-2-naththalaldehyde (10.0 g, 58 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 2-(benzo[d]thiazol-2-yl)naphthalen-1-ol (8.9 g, 32 mmol, 55%).

Compound (21) (1.5 g, 1.6 mmol, 67%) was obtained by repeating the same procedure as described in Preparation Example 1, but using 2-(benzo[d]thiazol-2-yl)naphthalen-1-ol (2.0 g, 7.2 mmol), ZnCl₂ (477.1 mg, 4.8 mmol), EtOH (120 mL, 0.02 M), NH₄OH (2.0 mL) and water (20 mL).

mp. >300° C.

¹H NMR (300 MHz, CDCl₃): d=8.23-8.1 (m, 3H), 7.7-7.5 (m, 3H), 7.4-7.3 (m, 4H)

MS/FAB: 956 (found), 956.78 (calculated)

### Preparation Example 22

### Preparation of Compound (22)

In 1,4-dioxane (50 mL, 4.0 M), dissolved were 2-aminobenzenethiol (24.8 g, 198 mmol) and 5-bromosalicylaldehyde (40 g, 198 mmol), and the solution was stirred at 100° C. under pressure for 12 hours. After cooling to room temperature, the reaction mixture was extracted with MC (300 mL), washed with distilled water (200 mL) and dried under reduced pressure. Purification via silica gel column chromatography (n-hexane: MC=2:1) gave 2-(benzo[d]thiazol-2-yl)-4-bromophenol (34 g, 118.4 mmol, 60%).

Under argon atmosphere, 2-(benzo[d]thiazol-2-yl)-4-bromophenol (4 g, 13.1 mmol) was dissolved in THF (50 mL, 0.03 M), and the solution was cooled to −78° C. To the solution, n-BuLi (2.5 M in hexane, 7.9 mL, 19.7 mmol) was added dropwise, and the mixture was stirred for 30 minutes. Triphenylsilyl chloride (TPSCl) (3.9 g, 13.1 mmol) dissolved in THF (25 mL, 0.5 M) was slowly added thereto. The reaction mixture was stirred for 12 hours while slowly raising the temperature to room temperature. After quenching the reaction by adding distilled water (100 mL), the reaction mixture was extracted with MC (50 mL). Drying under reduced pressure and purification via silica gel column chromatography (n-hexane: MC=5:1) gave 2-(benzo[d]thiazol-2-yl)-4-triphenylsilylphenol (3.9 g, 8.0 mmol, 61%).

Compound (22) (1.6 g, 1.0 mmol, 75%) was obtained by repeating the same procedure as described in Preparation Example 1, but using 2-(benzo[d]thiazol-2-yl)-4-triphenylsilylphenol (2.0 g, 4.1 mmol), ZnCl₂ (368 mg, 2.7 mmol), EtOH (70 mL, 0.02 M), NH₄OH (2.0 mL) and distilled water (20 mL).

mp. >300° C.

¹H NMR (300 MHz, CDCl₃): d=8.23-8.12 (m, 2H), 7.59-7.5 (m, 9H), 7.3-6.8 (m, 11H)

MS/FAB: 1584.22 (found), 1584.77 (calculated)

### Preparation Example 23

### Preparation of Compound (23)

In 1,4-dioxane (50 mL, 4.0 M), dissolved were 2-aminobenzenethiol (24.8 g, 198 mmol) and 5-bromosalicylaldehyde (40 g, 198 mmol), and the solution was stirred at 100° C. under pressure for 12 hours. After cooling to room temperature, the reaction mixture was extracted with MC (300 mL), washed with distilled water (200 mL) and dried under reduced pressure. Purification via silica gel column chromatography (n-hexane: MC=2:1) gave 2-(benzo[d]thiazol-2-yl)-4-bromophenol (34 g, 118.4 mmol, 60%).

The compound, 2-(benzo[d]thiazol-2-yl)-4-bromophenol (5 g, 16.33 mmol) and 4-bromophenylboronic acid (3.94 g, 19.6 mmol) were dissolved in toluene (40 mL), EtOH (27 mL) and H₂O (13 mL), and the solution was stirred. To the solution, added were PdCl₂(PPh₃)₂ (573 mg, 0.82 mmol) and K₂CO₃ (4.51 g, 32.66 mmol), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:4) gave 2-(benzo[d]thiazol-2-yl)-4-(4-bromophenyl)phenol (5.5 g, 14.5 mmol, 89%).

Under argon atmosphere, 2-(benzo[d]thiazol-2-yl)-4-(4-bromophenyl)phenol (4 g, 13.1 mmol) was dissolved in THF (50 mL, 0.03 M), and the solution was cooled to −78° C. To the solution, n-BuLi (2.5 M in hexane, 7.9 mL, 19.7 mmol) was added dropwise, and the mixture was stirred for 30 minutes. Triphenylsilyl chloride (TPSCl) (3.9 g, 13.1 mmol) dissolved in THF (25 mL, 0.5 M) was slowly added thereto. The reaction mixture was stirred for 12 hours while slowly raising the temperature to room temperature. After quenching the reaction by adding distilled water (100 mL), the reaction mixture was extracted with MC (50 mL). Drying under reduced pressure and purification via silica gel column chromatography (n-hexane: MC=5:1) gave 2-(benzo[d]thiazol-2-yl)-4-(4-triphenylsilylphenyl)phenol (4.8 g, 8.5 mmol, 65%).

Compound (23) (1.8 g, 1.0 mmol, 83%) was obtained by repeating the same procedure as described in Preparation Example 1, but using 2-(benzo[d]thiazol-2-yl)-4-(4-triphenylsilylphenyl)phenol (2.0 g, 3.6 mmol), ZnCl₂ (327 mg, 2.4 mmol), EtOH (60 mL, 0.02 M), NH₄OH (2.0 mL) and distilled water (20 mL).

mp. >300° C.

¹H NMR (300 MHz, CDCl₃): d=8.23-8.12 (m, 2H), 7.6-7.5 (m, 13H), 7.4-6.8 (m, 11H)

MS/FAB: 1808.31 (found), 1813.06 (calculated)

### Preparation Example 24

### Preparation of Compound (24)

The compound, 5-bromosalicylaldehyde (15 g, 74.6 mmol) and 4-fluorophenylboronic acid (11.5 g, 82.1 mmol) were dissolved in toluene (250 mL, 0.30 M), and the solution was stirred. To the solution, added were Pd(PPh₃)₄ (2.6 g, 2.24 mmol) and 2M K₂CO₃ (83 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:4) gave 5-(4-fluorophenyl)salicylaldehyde (14.2 g, 32.8 mmol, 88%).

In 1,4-dioxane (18 mL, 1.82 M), dissolved were 2-aminobenzenethiol (4.9 g, 39.4 mmol) and 5-(4-fluorophenyl)salicylaldehyde (7.1 g, 32.8 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 2-(benzo[d]thiazol-2-yl)-4-(4-fluorophenyl)phenol (8.4 g, 26 mmol, 79%).

Compound (24) (1.3 g, 1.2 mmol, 58%) was obtained by repeating the same procedure as described in Preparation Example 1, but using 2-(benzo[d]thiazol-2-yl)-4-(4-fluorophenyl)phenol (2.0 g, 6.2 mmol), ZnCl₂ (558.8 mg, 4.1 mmol), EtOH (100 mL, 0.02 M), NH₄OH (2.0 mL) and water (20 mL).

mp. >300° C.

¹H NMR (300 MHz, CDCl₃): d=8.23-8.12 (m, 2H), 7.56-7.27 (m, 6H), 7.03-6.98 (m, 2H), 6.85 (d, J=7.3 Hz, 1H)

MS/FAB: 1088 (found), 1091.86 (calculated)

### Preparation Example 25

### Preparation of Compound (25)

In 1,4-dioxane (25 mL, 2.6 M), dissolved were salicylaldehyde (8.0 g, 65.3 mmol) and 2-amino-5-(trifluoromethyl)benzenethiol (15.0 g, 65.3 mmol). After adding triethylamine (6.6 g, 65.3 mmol) thereto, the mixture was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 2-(6-trifluoromethyl)benzo[d]thiazol-2-yl)phenol (9.7 g, 32.9 mmol, 50%).

Compound (25) (1.0 g, 0.98 mmol, 82%) was obtained by repeating the same procedure as described in Preparation Example 1, but using 2-(6-(trifluoromethyl)benzo[d]thiazol-2-yl)phenol (1.1 g, 3.6 mmol), ZnCl₂ (327 mg, 2.4 mmol), EtOH (61 mL, 0.02 M), NH₄OH (1.2 mL) and water (12 mL).

mp. >300° C.

¹H NMR (300 MHz, CDCl₃): d=8.42 (s, 1H), 8.05 (d, J=6.4 Hz, 1H), 7.69-7.45 (m, 2H), 7.03-6.76 (m, 3H)

MS/FAB: 1009.92 (found), 1013.60 (calculated)

### Preparation Example 26

### Preparation of Compound (26)

Compound (26) (1.8 g, 2.2 mmol, 75%) was obtained by repeating the same procedure as described in Preparation Example 1, but using 2-(2-hydroxyphenyl)benzothiazole (2.0 g, 8.8 mmol), ZnI₂ (1.9 g, 5.9 mmol), EtOH (100 mL, 0.03 M), NH₄OH (2.0 mL) and water (20 mL).

mp. >300° C.

¹H NMR (300 MHz, CDCl₃): d=8.22-8.12 (m, 2H), 7.55 (m, 2H), 7.31 (d, J=7.7 Hz, 1H), 7.05 (t, J=7.2 Hz, 1H), 6.89 (t, J=7.6 Hz, 1H), 6.79 (d, J=7.2 Hz, 1H)

MS/FAB: 805.96 (found), 809.6 (calculated)

### Preparation Example 27

### Preparation of Compound (27)

Under argon atmosphere, 2-amino-6-bromobenzothiazole (20 g, 87.3 mmol) and 10 N KOH (100 mL) were added to ethylene glycol (20 mL), and the mixture was stirred at 125° C. under reflux for 15 hours. After cooling to room temperature, 12 N HCl (30 mL) was added to the reaction mixture to quench the reaction. The reaction mixture was then washed with water (100 mL) and extracted with EA (100 mL). Recrystallization from MeOH (200 mL) gave 2-amino-5-bromobenzenethiol (14 g, 68.6 mmol, 79%).

In 1,4-dioxane (35 mL, 2.0 M), dissolved were 2-amino-5-bromobenzenethiol (14 g, 68.6 mmol) and salicylaldehyde (7.0 g, 57.2 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=5:2) gave 2-(6-bromobenzo[d]thiazol-2-yl)phenol (15.5 g, 50.5 mmol, 88.3%).

Under argon atmosphere, 2-(6-bromobenzo[d]thiazol-2-yl)phenol (15.5 g, 50.5 mmol) and phenylboronic acid (9.2 g, 75.8 mmol) were dissolved in DME (200 mL, 0.25 M) and H₂O (66 mL), and the solution was stirred. To the solution, added were Pd(PPh₃)₄ (1.8 g, 1.5 mmol) and 2M K₂CO₃ (66 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:5) gave 2-(6-phenylbenzo[d]thiazol-2-yl)phenol (20.4 g, 42 mmol, 83%).

Compound (27) (2 g, 2.5 mmol, 85%) was obtained by repeating the same procedure as described in Preparation Example 1, but using 2-(6-phenylbenzo[d]thiazol-2-yl)phenol (2.0 g, 6.6 mmol), ZnCl₂ (600 mg, 4.4 mmol), EtOH (100 mL, 0.02 M), NH₄OH (2.0 mL) and water (20 mL).

mp. >300° C.

¹H NMR (300 MHz, CDCl₃): d=8.35-8.27 (m, 2H), 7.77-7.22 (m, 7H), 7.05-6.79 (m, 1H)

MS/FAB: 1034.05 (found), 1037.89 (calculated)

### Preparation Example 28

### Preparation of Compound (28)

The compound, 5-bromosalicylaldehyde (15 g, 74.6 mmol) and 4-tert-butylphenylboronic acid (14.6 g, 82.1 mmol) were dissolved in toluene (250 mL, 0.30 M), and the solution was stirred. To the solution, added were Pd(PPh₃)₄ (2.6 g, 2.24 mmol) and 2M K₂CO₃ (83 mL), and the resultant mixture was stirred at 90° C. under reflux for 4 hours. After quenching with water (100 mL) and washing, the reaction mixture was extracted with EA (200 mL). Drying under reduced pressure and purification via silica gel column chromatography (n-hexane: MC=1:3) gave 5-(4-tert-butylphenyl)salicylaldehyde (10.6 g, 41.7 mmol, 56%).

In 1,4-dioxane (18 mL, 1.82 M), dissolved were 2-aminobenzenethiol (4.9 g, 39.4 mmol) and 5-(4-tert-butylphenyl)salicylaldehyde (8.3 g, 32.8 mmol), and the solution was stirred at 100° C. under pressure for 12 hours. After cooling to room temperature, the reaction mixture was extracted with MC (150 mL), washed with water (100 mL) and dried under reduced pressure. Purification via silica gel column chromatography (n-hexane: MC=3:1) gave 2-(benzo[d]thiazol-2-yl)-4-(4-tert-butylphenyl)phenol (8.3 g, 23 mmol, 70%).

Compound (28) (1.81 g, 1.5 mmol, 73%) was obtained by repeating the same procedure as described in Preparation Example 1, but using 2-(benzo[d]thiazol-2-yl)-4-(4-tert-butylphenyl)phenol (2.0 g, 5.6 mmol), ZnCl₂ (558.8 mg, 4.1 mmol), EtOH (100 mL, 0.02 M), NH₄OH (2.0 mL) and water (20 mL).

mp. >300° C.

¹H NMR (300 MHz, CDCl₃): d=8.23-8.12 (m, 2H), 7.55-7.23 (m, 8H), 6.98-6.85 (d, J=5.3 Hz, 1H), 6.85 (d, J=7.3 Hz, 1H)

MS/FAB: 1202.24 (found), 1206.21 (calculated)

### Preparation Example 29

### Preparation of Compound (29)

In polyphosphoric acid (20 g), dissolved were 2-aminobenzenethiol (4.9 g, 39.4 mmol) and 2-mercaptobenzoic acid (5.1 g, 32.8 mmol), and the solution was stirred at 140° C. for 12 hours. After cooling to room temperature, the reaction was quenched by adding NaOH. Washing with water and drying under reduced pressure gave 2-(benzo[d]thiazol-2-yl)benzenethiol (6.1 g, 25 mmol, 76%).

Compound (29) (1.5 g, 1.7 mmol, 62%) was obtained by repeating the same procedure as described in Preparation Example 1, but using 2-(benzo[d]thiazol-2-yl)benzenethiol (2.0 g, 8.2 mmol), ZnCl₂ (749.7 mg, 5.5 mmol), EtOH (100 mL, 0.028 M), NH₄OH (2.0 mL) and water (20 mL).

mp. >300° C.

¹H NMR (300 MHz, CDCl₃): d=8.23-8.12 (m, 2H), 7.55-7.06 (m, 6H)

MS/FAB: 853.89 (found), 857.80 (calculated)

### Preparation Example 30

### Preparation of Compound (30)

In DME (600 mL, 0.305 M), dissolved were 5-iodoisatin (50 g, 183 mmol) and phenylboronic acid (24.5 g, 201.3 mmol), and the solution was stirred. After adding Pd(PPh₃)₄ (6.34 g, 5.49 mmol) and 2M NaHCO₃ (200 mL) thereto, the resultant mixture was stirred at 100° C. under reflux for 12 hours. The reaction mixture containing 5-phenylisatin was dried under low vacuum, and 5% NaOH (120 mL) was added to the residual aqueous solution. After removing the impurities by extracting with CH₂Cl₂, added was H₂O₂ (120 mL) to the aqueous layer, and the resultant mixture was stirred at 50° C. for 30 minutes. The mixture was cooled to room temperature, and filtered. The filtrate was adjusted to have pH of 4. Filtration of the solid compound gave 2-amino-5-phenylbenzoic acid (24.3 g, 114 mmol, 62%).

While maintaining the temperature at 5° C., NaNO₂ (7.9 g, 114 mmol) was dissolved in water (30 mL), and a solution of 2-amino-5-phenylbenzoic acid (24.3 g, 114 mmol) dissolved in water (60 mL), and concentrated HCl (23 mL) were slowly added thereto. At the same time, Na₂S9H₂O (28.8 g, 120 mmol) and refined sulfur (3.85 g, 120 mmol) were dissolved in water (30 mL), and 10 M NaOH (11 mL) was added thereto. The mixture was cooled to 5° C., and added to the solution containing 2-amino-5-phenylbenzoic acid. The resultant mixture was stirred while slowly raising the temperature to room temperature. Concentrated HCl was added to generate solid, and the mixture was washed with NaHCO₃ (250 mL). The solid generated was filtered and dried, and then added to glacial acetic acid (100 mL) along with Zn dust (7 g, 107 mmol). The mixture was stirred under reflux for 48 hours. After quenching with concentrated HCl, the solid was filtered and washed with EtOH (100 mL) to obtain 2-mercapto-5-phenylbenzoic acid (17.3 g, 75 mmol, 66%).

In polyphosphoric acid (40 g), dissolved were 2-mercapto-5-phenylbenzoic acid (17.3 g, 75 mmol) and 2-aminobenzenethiol (10.3 g, 82.5 mmol), and the solution was stirred at 140° C. for 12 hours. After cooling to room temperature, the reaction was quenched by adding NaOH. Washing with water and drying under reduced pressure gave 2-(benzo[d]thiazol-2-yl)-4-phenylbenzenethiol (12.8 g, 40 mmol, 53%).

Compound (30) (1.7 g, 1.6 mmol, 76%) was obtained by repeating the same procedure as described in Preparation Example 1, but using 2-(benzo[d]thiazol-2-yl)-4-phenylbenzenethiol (2.0 g, 6.3 mmol), ZnCl₂ (558.8 mg, 4.1 mmol), EtOH (80 mL, 0.026 M), NH₄OH (2.0 mL) and water (20 mL).

mp. >300° C.

¹H NMR (300 MHz, CDCl₃): d=8.23-8.10 (m, 2H), 7.55-7.22 (m, 12H)

MS/FAB: 1081.98 (found), 1086.09 (calculated)

### Preparation Example 31

### Preparation of Compound (31)

In DME (600 mL, 0.305 M), dissolved were 5-iodoisatin (50 g, 183 mmol) and naphthalen-2-yl-2-boronic acid (34.6 g, 201.3 mmol), and the solution was stirred. After adding Pd(PPh₃)₄ (6.34 g, 5.49 mmol) and 2M NaHCO₃ (200 mL) thereto, the resultant mixture was stirred at 100° C. under reflux for 12 hours. The reaction mixture containing 5-(naphthalen-3-yl) isatin thus produced was dried under low vacuum, and 5% NaOH (120 mL) was added to the residual aqueous solution. After removing the impurities by extracting with CH₂Cl₂, added was H₂O₂ (120 mL) to the aqueous layer, and the resultant mixture was stirred at 50° C. for 30 minutes. The mixture was cooled to room temperature, and filtered. The filtrate was adjusted to have pH of 4. Filtration of the solid compound gave 2-amino-5-(naphthalen-3-yl)benzoic acid (32.9 g, 125 mmol, 68%).

While maintaining the temperature at 5° C., NaNO₂ (8.3 g, 120 mmol) was dissolved in water (40 mL), and a solution of 2-amino-5-(naphthalen-3-yl) benzoic acid (32.9 g, 125 mmol) dissolved in water (70 mL), and concentrated HCl (30 mL) were slowly added thereto. At the same time, Na₂S9H₂O (30.0 g, 125 mmol) and refined sulfur (4.01 g, 125 mmol) were dissolved in water (40 mL), and 10 M NaOH (15 mL) was added thereto. The mixture was cooled to 5° C., and added to the solution containing 2-amino-5-(naphthalen-3-yl) benzoic acid dissolved therein. The resultant mixture was stirred while slowly raising the temperature to room temperature. Concentrated HCl was added to generate solid, and the mixture was washed with NaHCO₃ (250 mL). The solid generated was filtered and dried, and then added to glacial acetic acid (100 mL) along with Zn dust (7 g, 107 mmol). The mixture was stirred under reflux for 48 hours. After quenching with concentrated HCl, the solid was filtered and washed with EtOH (100 mL) to obtain 2-mercapto-5-(naphthalen-3-yl)benzoic acid (22.4 g, 80 mmol, 64%).

In polyphosphoric acid (40 g), dissolved were 2-mercapto-5-(naphthalen-3-yl)benzoic acid (22.4 g, 80 mmol) and 2-aminobenzenethiol (11.0 g, 88 mmol), and the solution was stirred at 140° C. for 12 hours. After cooling to room temperature, the reaction was quenched by adding NaOH. Washing with water and drying under reduced pressure gave 2-(benzo[d]thiazol-2-yl)-4-(naphthalen-3-yl)benzenethiol (15.5 g, 42 mmol, 53%).

Compound (31) (1.4 g, 1.13 mmol, 63%) was obtained by repeating the same procedure as described in Preparation Example 1, but using 2-(benzo[d]thiazol-2-yl)-4-(naphthalen-3-yl)benzenethiol (2.0 g, 5.4 mmol), ZnCl₂ (490.7 mg, 3.6 mmol), EtOH (70 mL, 0.026 M), NH₄OH (2.0 mL) and water (20 mL).

mp. >300° C.

¹H NMR (300 MHz, CDCl₃): d=8.23-8.14 (m, 2H), 7.9-7.3 (m, 12H)

MS/FAB: 1232.03 (found), 1236.27 (calculated)

### Preparation Example 32

### Preparation of Compound (32)

In DME (600 mL, 0.305 M), dissolved were 5-iodoisatin (50 g, 183 mmol) and 9,9-dimethyl-9H-fluoren-2-yl-2-boronic acid (47.9 g, 201.3 mmol), and the solution was stirred. After adding Pd(PPh₃)₄ (6.34 g, 5.49 mmol) and 2M NaHCO₃ (200 mL) thereto, the resultant mixture was stirred at 100° C. under reflux for 12 hours. The reaction mixture containing 5-(9,9-dimethyl-9H-fluoren-2-yl)isatin thus produced was dried under low vacuum, and 5% NaOH (120 mL) was added to the residual aqueous solution. After removing the impurities by extracting with CH₂Cl₂, added was H₂O₂ (120 mL) to the aqueous layer, and the resultant mixture was stirred at 50° C. for 30 minutes. The mixture was cooled to room temperature, and filtered. The filtrate was adjusted to have pH of 4. Filtration of the solid compound gave 2-amino-5-(9,9-dimethyl-9H-fluoren-2-yl)benzoic acid (24.0 g, 110 mmol, 57%).

While maintaining the temperature at 5° C., NaNO₂ (6.9 g, 100 mmol) was dissolved in water (40 mL), and a solution of 2-amino-5-(9,9-dimethyl-9H-fluoren-2-yl)benzoic acid (36.2 g, 110 mmol) dissolved in water (70 mL), and concentrated HCl (30 mL) were slowly added thereto. At the same time, Na₂S9H₂O (26.4 g, 110 mmol) and refined sulfur (3.53 g, 110 mmol) were dissolved in water (40 mL), and 10 M NaOH (15 mL) was added thereto. The mixture was cooled to 5° C., and added to the solution containing 2-amino-5-(9,9-dimethyl-9H-fluoren-2-yl)benzoic acid dissolved therein. The resultant mixture was stirred while slowly raising the temperature to room temperature. Concentrated HCl was added to generate solid, and the mixture was washed with NaHCO₃ (250 mL). The solid generated was filtered and dried, and then added to glacial acetic acid (100 mL) along with Zn dust (7 g, 107 mmol). The mixture was stirred under reflux for 48 hours. After quenching with concentrated HCl, the solid was filtered and washed with EtOH (100 mL) to obtain 2-mercapto-5-(9,9-dimethyl-9H-fluoren-2-yl)benzoic acid (26.0 g, 75 mmol, 68%).

In polyphosphoric acid (40 g), dissolved were 2-mercapto-5-(9,9-dimethyl-9H-fluoren-2-yl)benzoic acid (26.0 g, 75 mmol) and 2-aminobenzenethiol (10.3 g, 82.5 mmol), and the solution was stirred at 140° C. for 12 hours. After cooling to room temperature, the reaction was quenched by adding NaOH. Washing with water and drying under reduced pressure gave 2-(benzo[d]thiazol-2-yl)-4-(9,9-dimethyl-9H-fluoren-2-yl)benzenethiol (22.2 g, 51 mmol, 68%).

Compound (32) (1.1 g, 0.77 mmol, 50.3%) was obtained by repeating the same procedure as described in Preparation Example 1, but using 2-(benzo[d]thiazol-2-yl)-4-(9,9-dimethyl-9H-fluoren-2-yl)benzenethiol (2.0 g, 4.6 mmol), ZnCl₂ (417.1 mg, 3.06 mmol), EtOH (60 mL, 0.026 M), NH₄OH (2.0 mL) and water (2.0 mL).

mp. >300° C.

¹H NMR (300 MHz, CDCl₃): d=8.23-8.12 (m, 2H), 7.9-7.54 (m, 8H), 1.67 (s, 6H)

MS/FAB: 1432.19 (found), 1436.59 (calculated)

### Preparation Example 33

### Preparation of Compound (33)

In DME (600 mL, 0.305 M), dissolved were 5-iodoisatin (50 g, 183 mmol) and 4-fluorophenylboronic acid (28.2 g, 201.3 mmol), and the solution was stirred. After adding Pd(PPh₃)₄ (6.34 g, 5.49 mmol) and 2M NaHCO₃ (200 mL) thereto, the resultant mixture was stirred at 100° C. under reflux for 12 hours. The reaction mixture containing 5-(4-fluorophenyl)isatin thus produced was dried under low vacuum, and 5% NaOH (120 mL) was added to the residual aqueous solution. After removing the impurities by extracting with CH₂Cl₂, added was H₂O₂ (120 mL) to the aqueous layer, and the resultant mixture was stirred at 50° C. for 30 minutes. The mixture was cooled to room temperature, and filtered. The filtrate was adjusted to have pH of 4. Filtration of the solid compound gave 2-amino-5-(4-fluorophenyl)benzoic acid (24.0 g, 104 mmol, 57%).

While maintaining the temperature at 5° C., NaNO₂ (6.8 g, 98 mmol) was dissolved in water (40 mL), and a solution of 2-amino-5-(4-fluorophenyl)benzoic acid (24.0 g, 104 mmol) dissolved in water (70 mL), and concentrated HCl (30 mL) were slowly added thereto. At the same time, Na₂S9H₂O (25.0 g, 104 mmol) and refined sulfur (3.33 g, 104 mmol) were dissolved in water (40 mL), and 10 M NaOH (15 mL) was added thereto. The mixture was cooled to 5° C., and added to the solution containing (33-2). The resultant mixture was stirred while slowly raising the temperature to room temperature. Concentrated HCl was added to generate solid, and the mixture was washed with NaHCO₃ (150 mL). The solid generated was filtered and dried, and then added to glacial acetic acid (80 mL) along with Zn dust (6.5 g, 100 mmol). The mixture was stirred under reflux for 48 hours. After quenching with concentrated HCl, the solid was filtered and washed with EtOH (100 mL) to obtain 2-mercapto-5-(4-fluorophenyl)benzoic acid (16.9 g, 68 mmol, 65%).

In polyphosphoric acid (30 g), dissolved were 2-mercapto-5-(4-fluorophenyl)benzoic acid (16.9 g, 68 mmol) and 2-aminobenzenethiol (9.4 g, 74.8 mmol), and the solution was stirred at 140° C. for 12 hours. After cooling to room temperature, the reaction was quenched by adding NaOH. Washing with water and drying under reduced pressure gave 2-(benzo[d]thiazol-2-yl)-4-(4-fluorophenyl)benzenethiol (13.8 g, 41 mmol, 68%).

Compound (33) (1.74 g, 1.53 mmol, 78%) was obtained by repeating the same procedure as described in Preparation Example 1, but using 2-(benzo[d]thiazol-2-yl)-4-(4-fluorophenyl)benzenethiol (2.0 g, 5.9 mmol), ZnCl₂ (535.7 mg, 3.93 mmol), EtOH (80 mL, 0.025 M), NH₄OH (2.0 mL) and water (2.0 mL).

mp. >300° C.

¹H NMR (300 MHz, CDCl₃): d=8.23-8.12 (m, 2H), 7.55-7.2 (m, 9H)

MS/FAB: 1135.95 (found), 1140.06 (calculated)

### Preparation Example 34

### Preparation of Compound (34)

In DME (600 mL, 0.305 M), dissolved were 5-iodoisatin (50 g, 183 mmol) and 4-tert-butylphenylboronic acid (35.8 g, 201.3 mmol), and the solution was stirred. After adding Pd(PPh₃)₄ (6.34 g, 5.49 mmol) and 2M NaHCO₃ (200 mL) thereto, the resultant mixture was stirred at 100° C. under reflux for 12 hours. The reaction mixture containing 5-(4-tert-butylphenyl)isatin thus produced was dried under low vacuum, and 5% NaOH (120 mL) was added to the residual aqueous solution. After removing, the impurities by extracting with CH₂Cl₂, added was H₂O₂ (120 mL) to the aqueous layer, and the resultant mixture was stirred at 50° C. for 30 minutes. The mixture was cooled to room temperature, and filtered. The filtrate was adjusted to have pH of 4. Filtration of the solid compound gave 2-amino-5-(4-tert-butylphenyl)benzoic acid (29.9 g, 111 mmol, 61%).

While maintaining the temperature at 5° C., NaNO₂ (6.8 g, 98 mmol) was dissolved in water (40 mL), and a solution of 2-amino-5-(4-tert-butylphenyl)benzoic acid (29.9 g, 111 mmol) dissolved in water (80 mL) and concentrated HCl (40 mL) were slowly added thereto. At the same time, Na₂S9H₂O (26.7 g, 111 mmol) and refined sulfur (3.56 g, 104 mmol) were dissolved in water (40 mL), and 10 M NaOH (15 mL) was added thereto. The mixture was cooled to 5° C., and added to the solution containing 2-amino-5-(4-tert-butylphenyl)benzoic acid dissolved therein. The resultant mixture was stirred while slowly raising the temperature to room temperature. Concentrated HCl was added to generate solid, and the mixture was washed with NaHCO₃ (150 mL). The solid generated was filtered and dried, and then added to glacial acetic acid (80 mL) along with Zn dust (6.9 g, 105 mmol). The mixture was stirred under reflux for 48 hours. After quenching with concentrated HCl, the solid was filtered and washed with EtOH (100 mL) to obtain 2-mercapto-5-(4-tert-butylphenyl)benzoic acid (20.0 g, 70 mmol, 63%).

In polyphosphoric acid (30 g), dissolved were 2-mercapto-5-(4-tert-butylphenyl)benzoic acid (20.0 g, 70 mmol) and 2-aminobenzenethiol (9.6 g, 77 mmol), and the solution was stirred at 140° C. for 12 hours. After cooling to room temperature, the reaction was quenched by adding NaOH. Washing with water and drying under reduced pressure gave 2-(benzo[d]thiazol-2-yl)-4-(4-tert-butylphenyl)benzenethiol (19.9 g, 53 mmol, 76%).

Compound (34) (1.73 g, 1.38 mmol, 78%) was obtained by repeating the same procedure as described in Preparation Example 1, but using 2-(benzo[d]thiazol-2-yl)-4-(4-tert-butylphenyl)benzenethiol (2.0 g, 5.3 mmol), ZnCl₂ (481.1 mg, 3.53 mmol), EtOH (70 mL, 0.025 M), NH₄OH (2.0 mL) and water (2.0 mL).

mp. >300° C.

¹H NMR (300 MHz, CDCl₃): d=8.23-8.12 (m, 2H), 7.55-7.28 (m, 9H), 1.35 (s, 9H)

MS/FAB: 1250.17 (found), 1254.41 (calculated)

### Example 1-34

### Manufacture of an OLED Using the Compound According to the Present Invention

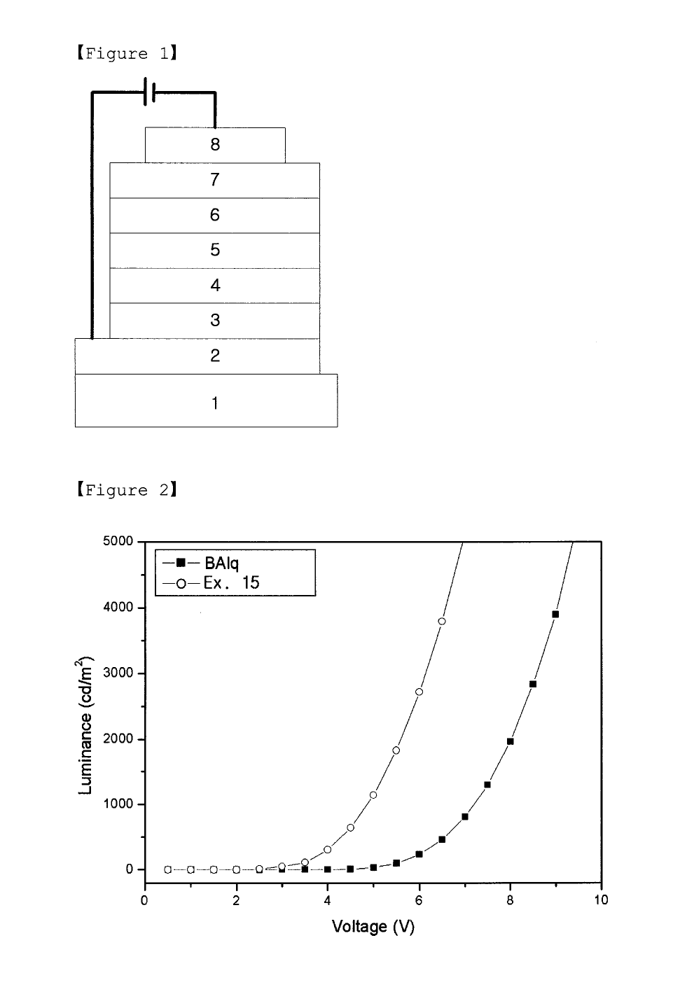

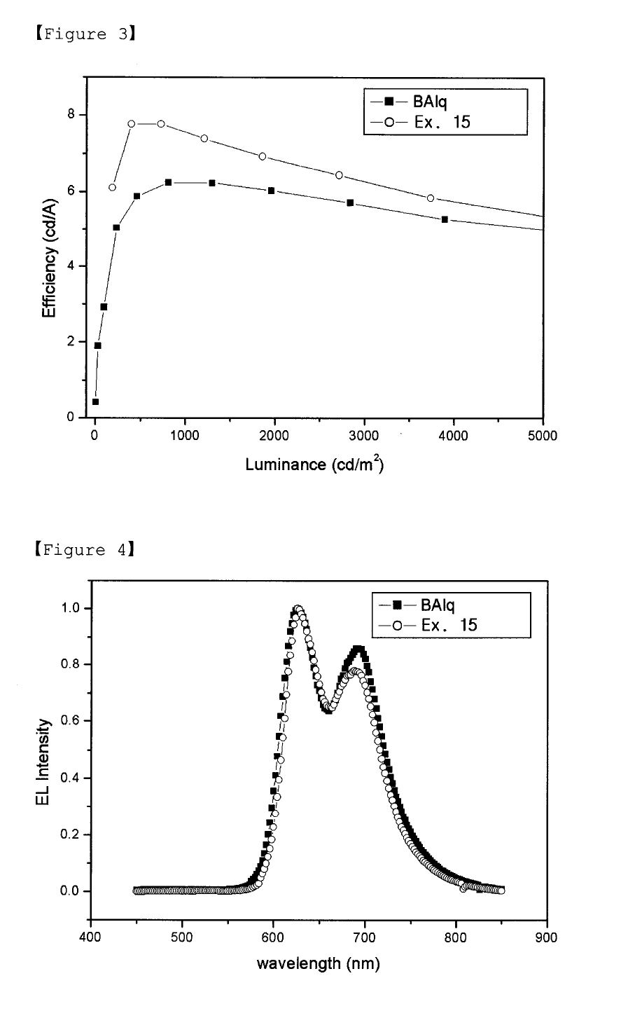

An OLED device was manufactured by using the compound according to the present invention as a host, and a red phosphorescent material as an EL dopant. The cross-sectional view of the OLED device is shown in FIG. 1.

First, a substrate prepared by coating a transparent electrode ITO thin film (2) (15 Ω/□, produced by Samsung Corning) on glass (1) was subjected to ultrasonic washing with trichloroethylene, acetone, ethanol and distilled water, subsequently, and stored in isopronanol before use.

Then, an ITO substrate was equipped in a substrate folder of a vacuum vapor-deposit device, and 4,4′,4″-tris(N,N-(2-naphthyl)-phenylamino)triphenylamine (2-TNATA) was placed in a cell of the vacuum vapor-deposit device, which was then vented to reach 10-6 torr of vacuum in the chamber. Electric current was applied to the cell to evaporate 2-TNATA to vapor-deposit a hole injection layer (3) having 60 nm of thickness on the ITO substrate.

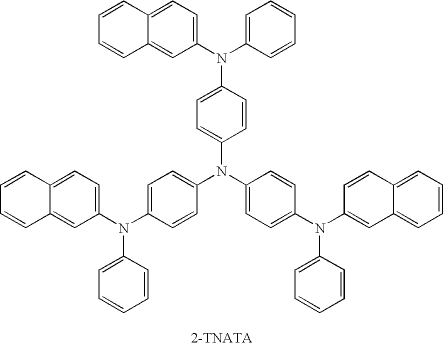

Then, another cell of the vacuum vapor-deposit device was charged with N,N′-bis(α-naphthyl)-N,N′-diphenyl-4,4′-diamine (NPB), and electric current was applied to the cell to evaporate NPB to vapor-deposit a hole transportation layer (4) with 20 nm of thickness on the hole injection layer.

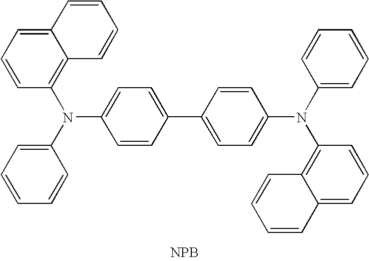

One cell of the vacuum deposition device was charged with a selected EL compound (from Compounds (1) to (34) prepared from Preparation Examples 1 to 34) which had been purified by vacuum sublimation under 10-6 torr, as a host material. Another cell of said device was charged with (pip)2Ir(acac) or (pq-Fl)2Ir(acac), respectively. The two materials were evaporated at different rates to carry out doping in a concentration of 4 to 10 mol %, to vapor-deposit an electroluminescent layer (5) with 30 nm of thickness on the hole transportation layer.

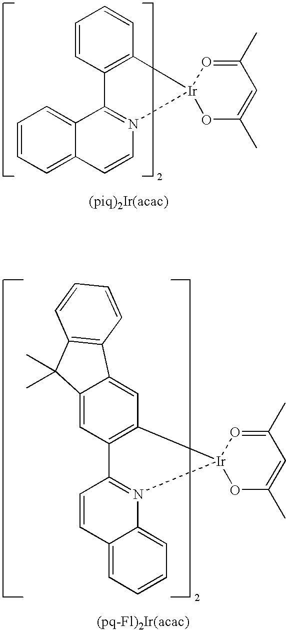

Then, tris(8-hydroxyquinoline)-aluminum (III) (Alq) was vapor-deposited with a thickness of 20 nm, as an electron transportation layer (6), followed by lithium quinolate (Liq) with a thickness of from 1 to 2 nm as an electron injection layer (7). Thereafter, an Al cathode (8) was vapor-deposited in a thickness of 150 nm by using another vacuum vapor-deposit device to manufacture an OLED.

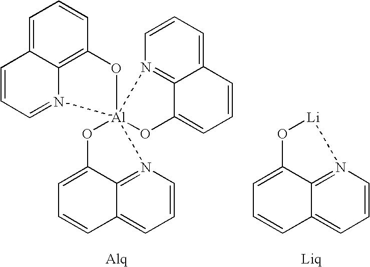

### Comparative Example 1

An OLED device was manufactured according to the same procedure as described in Example 1, except that another cell in the vapor-deposition device was charged with bis(2-methyl-8-quinolinato)(p-phenylphenolato)aluminum (III) (BAlq) instead of the EL compound according to the present invention, as EL host material, and still another cell were charged with (piq)₂Ir(acac) or (pq-Fl)₂Ir(acac), respectively, as the EL dopant material identical to that of Example 1. By evaporating the two substances in different rates, an EL layer was vapor-deposited by doping in a concentration of 4 to 10 mol % on the basis of BAlq, with a thickness of 30 nm on the hole transportation layer.

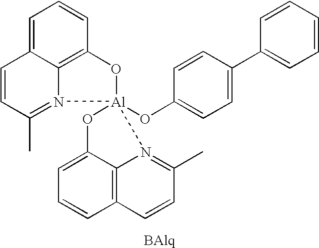

### Example 35

### Determination of Properties of OLED

Current luminous efficiency and power efficiency of OLED's containing the EL compounds according to the present invention (Examples 1 to 34) and a conventional EL compound (Comparative Example 1) were measured at 1,000 cd/m2. The results are shown in Table 1:

TABLE 1

| | | | Operation | Luminous | Power | Color |
|---|---|---|---|---|---|---|
| | Host | El | Voltage | Efficiency | Efficiency | Coordinate |
| | material | material | (V)@1,000 cd/m² | (cd/A)@1,000 cd/m² | (lm/W)@1,000 cd/m² | (x, y) |
| Ex. 1 | 1 | (piq)₂Ir(acac) | 5.55 | 7.65 | 4.3 | (0.671, 0.328) |
| Ex. 2 | 2 | (piq)₂Ir(acac) | 5.8 | 7.6 | 4.1 | (0.673, 0.325) |
| Ex. 3 | 3 | (pq-Fl)₂Ir(acac) | 5.8 | 7.5 | 4.1 | (0.672, 0.327) |
| Ex. 4 | 4 | (piq)₂Ir(acac) | 5.4 | 5.1 | 3.0 | (0.673, 0.325) |
| Ex. 5 | 5 | (pq-Fl)₂Ir(acac) | 5.7 | 7.6 | 4.2 | (0.671, 0.327) |
| Ex. 6 | 6 | (pq-Fl)₂Ir(acac) | 5.3 | 6.0 | 3.6 | (0.672, 0.325) |
| Ex. 7 | 7 | (pq-Fl)₂Ir(acac) | 5.0 | 7.0 | 4.4 | (0.672, 0.325) |
| Ex. 8 | 8 | (pq-Fl)₂Ir(acac) | 5.0 | 6.1 | 3.8 | (0.671, 0.328) |
| Ex. 9 | 9 | (pq-Fl)₂Ir(acac) | 5.5 | 7.2 | 4.1 | (0.669, 0.329) |
| Ex. 10 | 10 | (pq-Fl)₂Ir(acac) | 5.2 | 7.3 | 4.4 | (0.670, 0.328) |
| Ex. 11 | 11 | (piq)₂Ir(acac) | 5.3 | 7.8 | 4.6 | (0.673, 0.325) |
| Ex. 12 | 12 | (piq)₂Ir(acac) | 5.4 | 8.0 | 4.7 | (0.673, 0.325) |
| Ex. 13 | 13 | (piq)₂Ir(acac) | 5.3 | 7.2 | 4.3 | (0.673, 0.325) |
| Ex. 14 | 14 | (piq)₂Ir(acac) | 4.9 | 6.8 | 4.4 | (0.673, 0.325) |
| Ex. 15 | 15 | (piq)₂Ir(acac) | 5.1 | 7.5 | 4.6 | (0.673, 0.325) |
| Ex. 16 | 16 | (piq)₂Ir(acac) | 5.2 | 7.3 | 4.4 | (0.674, 0.324) |
| Ex. 17 | 17 | (piq)₂Ir(acac) | 4.8 | 7.5 | 4.9 | (0.673, 0.325) |
| Ex. 18 | 18 | (piq)₂Ir(acac) | 5.4 | 7.7 | 4.5 | (0.673, 0.325) |
| Ex. 19 | 19 | (piq)₂Ir(acac) | 5.5 | 7.0 | 4.0 | (0.673, 0.325) |
| Ex. 20 | 20 | (piq)₂Ir(acac) | 5.3 | 7.2 | 4.3 | (0.673, 0.325) |
| Ex. 21 | 21 | (piq)₂Ir(acac) | 5.0 | 7.0 | 4.4 | (0.673, 0.325) |
| Ex. 22 | 22 | (piq)₂Ir(acac) | 4.9 | 7.7 | 4.9 | (0.673, 0.325) |
| Ex. 23 | 23 | (piq)₂Ir(acac) | 5.2 | 7.5 | 4.5 | (0.673, 0.325) |
| Ex. 24 | 24 | (piq)₂Ir(acac) | 5.4 | 6.8 | 3.9 | (0.673, 0.325) |
| Ex. 25 | 25 | (piq)₂Ir(acac) | 5.4 | 6.5 | 3.8 | (0.673, 0.325) |
| Ex. 26 | 26 | (piq)₂Ir(acac) | 5.5 | 7.5 | 4.3 | (0.673, 0.325) |
| Ex. 27 | 27 | (piq)₂Ir(acac) | 5.3 | 7.6 | 4.5 | (0.673, 0.325) |
| Ex. 28 | 28 | (piq)₂Ir(acac) | 5.1 | 7.1 | 4.4 | (0.673, 0.325) |
| Ex. 29 | 29 | (piq)₂Ir(acac) | 5.2 | 7.8 | 4.7 | (0.673, 0.325) |
| Ex. 30 | 30 | (piq)₂Ir(acac) | 5.0 | 7.4 | 4.6 | (0.673, 0.325) |
| Ex. 31 | 31 | (piq)₂Ir(acac) | 5.3 | 6.9 | 4.1 | (0.672, 0.326) |
| Ex. 32 | 32 | (piq)₂Ir(acac) | 5.3 | 6.7 | 4.0 | (0.673, 0.325) |
| Ex. 33 | 33 | (piq)₂Ir(acac) | 5.0 | 7.6 | 4.8 | (0.673, 0.325) |
| Ex. 34 | 34 | (piq)₂Ir(acac) | 5.3 | 7.7 | 4.6 | (0.674, 0.324) |
| Comp. | BAlq | (piq)₂Ir(acac) | 7.5 | 6.2 | 2.6 | (0.675, 0.323) |
| Ex. 1 | | | | | | |

As can be seen from Table 1, the complexes developed according to the present invention show superior EL properties in view of performances as compared to conventional materials. In particular, the improvement in power consumption due to the lowered operation voltage is not simply resulted from the improvement in luminous efficiency, but from the improvement of the current properties, as can be seen from Table 1.

These are resulted from specific structure of the molecule of host material according to the present invention and the effect of metal ion complex, and it is interpreted that properties of the thin film are improved due to these structural feature of the molecule. Table 1 shows that, the properties of thin film and EL properties are more prominently improved as comprising a soft element having larger atomic number, and an aromatic ring as the side chain.

It is confirmed that the host material according to the present invention has excellent energy transmission property from the phenomenon of maintaining the EL properties of the dopant itself, regardless of the electroluminescent wavelength range of the host itself. This is a very important property required for a host material, providing advantage from the viewpoint of ensuring the process margin to the doping concentration of the dopant.

### INDUSTRIAL APPLICABILITY

The electroluminescent compounds according to the present invention provide advantages, when they are employed as host material of phosphorescent material in an OLED device, of noticeably lowering the operation voltage, enhancing current efficiency, and thus improving the power efficiency as compared to conventional host material. These EL compounds are expected to significantly contribute to reduce power consumption of an OLED.

1. An electroluminescent compound represented by Chemical Formula (1):
L¹L²L³M₂Q [Chemical Formula 1]
wherein, the ligands (L1, L2 and L3) are independently selected from the structures represented by following chemical structure; M is a bivalent metal; and Q is a monovalent anion derived from an inorganic or an organic acid. 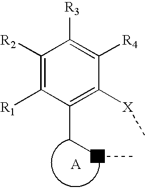
[In the ligands, X is O, S or Se; ring A is oxazole, thiazole, imidazole, oxadiazole, thiadiazole, benzoxazole, benzothiazole, benzoimidazole, pyridine or quinoline; R1 through R4 independently represent hydrogen, C1-C5 alkyl, halogen, silyl group or C6-C20 aryl, or they may be bonded to an adjacent substituent via alkylene or alkenylene to form a fused ring; and the pyridine and quinoline may chemically bonded to R1 to form a fused ring; and the ring A and aryl group of R1 through R4 may be further substituted by C1-C5 alkyl, halogen, C1-C5 alkyl having halogen substituent(s), phenyl, naphthyl, silyl or amino group.]

2. An electroluminescent compound according to claim 1, wherein L1, L2 and L3 are selected from one of the following chemical structures: 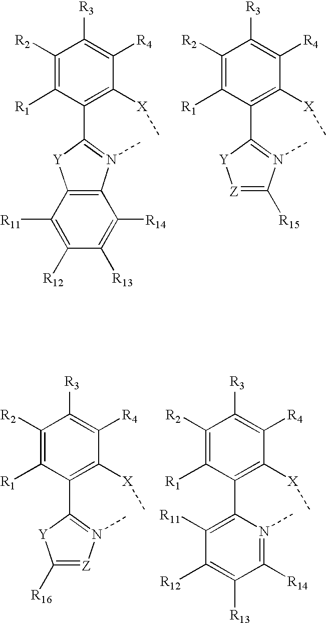
wherein, X and R1 through R4 are defined as in claim 1; Y is O, S or NR21, Z is CH or N; R11 through R16 independently represent hydrogen, C1-C5 alkyl, halogen, C1-C5 alkyl having halogen substituent(s), phenyl, naphthyl, silyl or amino group, R11 through R14 may be bonded to an adjacent substituent via alkylene or alkenylene to form a fused ring, and R21 is C1-C5 alkyl, substituted or unsubstituted phenyl or naphthyl group.

3. An electroluminescent compound according to claim 1, wherein M is selected from Be, Zn, Mg, Cu and Ni.

4. An electroluminescent compound according to claim 2, wherein the ligands (L1, L2 and L3) are identical, and selected from the structures represented by one of the following chemical formulas: 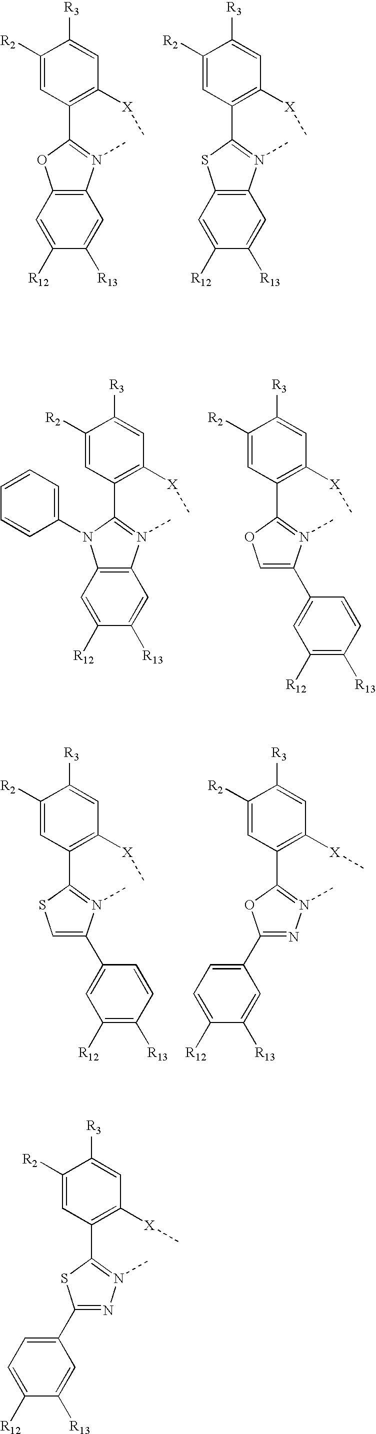
wherein, X is O, S or Se, and R2, R3, R12 and R13 independently represent hydrogen, methyl, ethyl, n-propyl, isopropyl, fluorine, chlorine, trifluoromethyl, phenyl, naphthyl, fluorenyl, trimethylsilyl, triphenylsilyl, t-butyldimethylsilyl, dimethylamine, diethylamine or diphenylamine; and the phenyl, naphthyl or fluorenyl may be further substituted by fluorine, chlorine, trimethylsilyl, triphenylsilyl, t-butyldimethylsilyl, dimethylamine, diethylamine or diphenylamine.

5. An electroluminescent compound according to claim 4, which is selected from the compounds represented by one of the following chemical formulas:

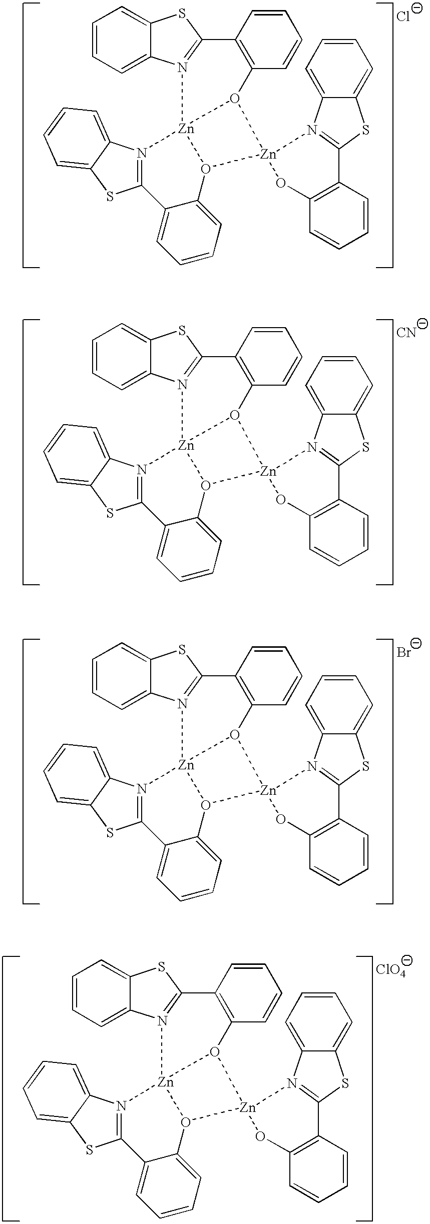

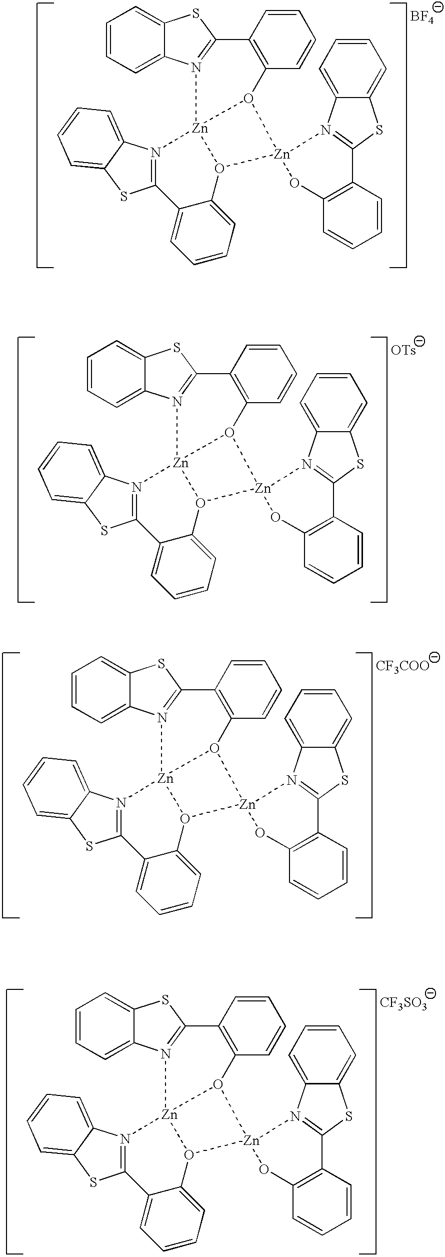

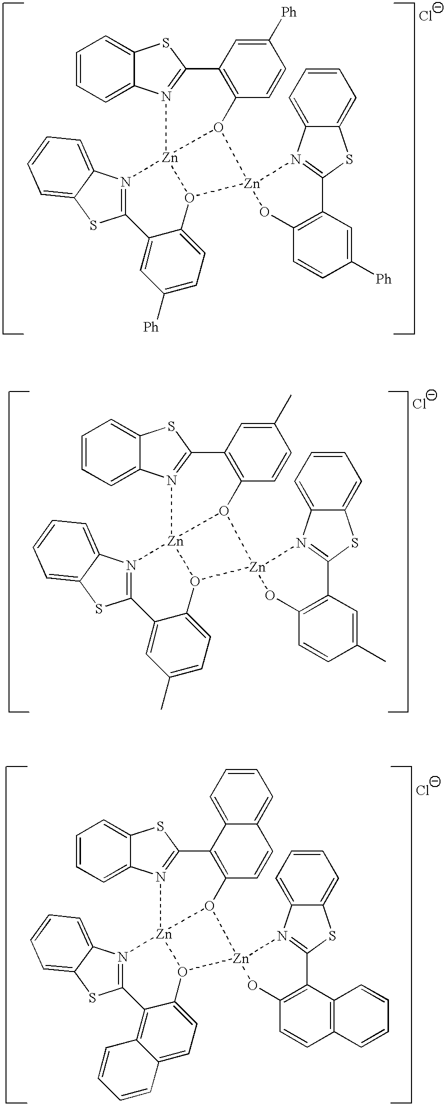

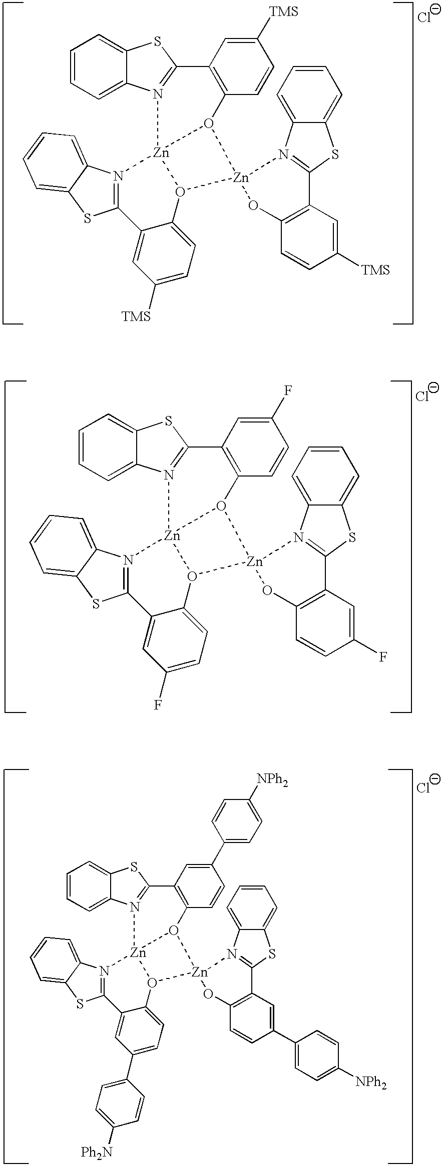

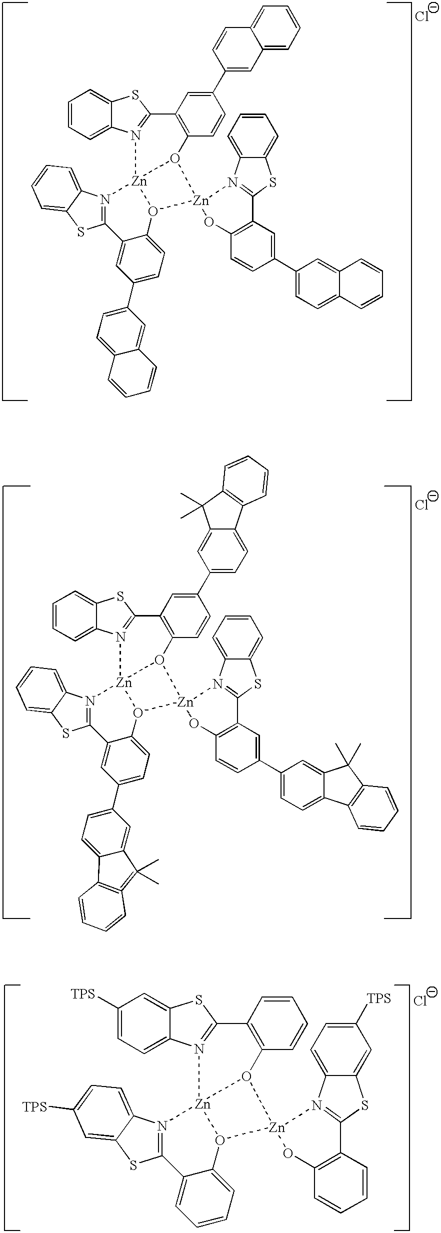

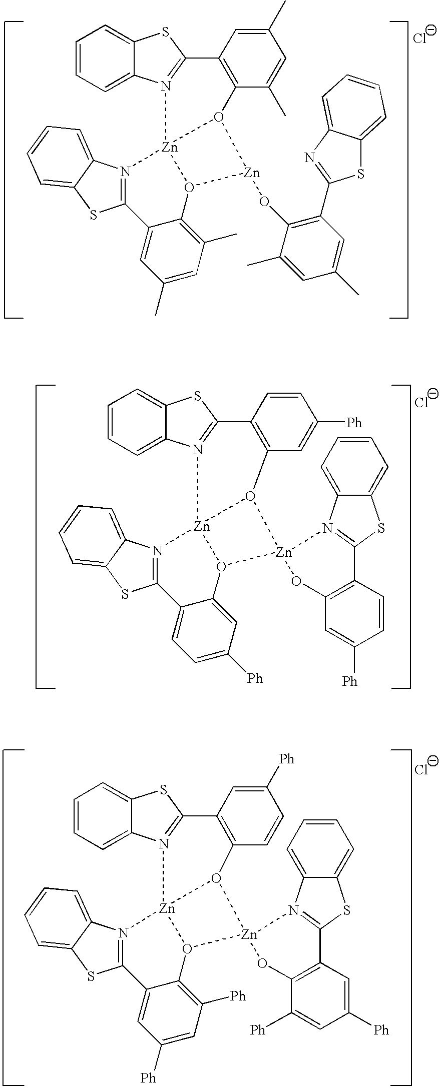

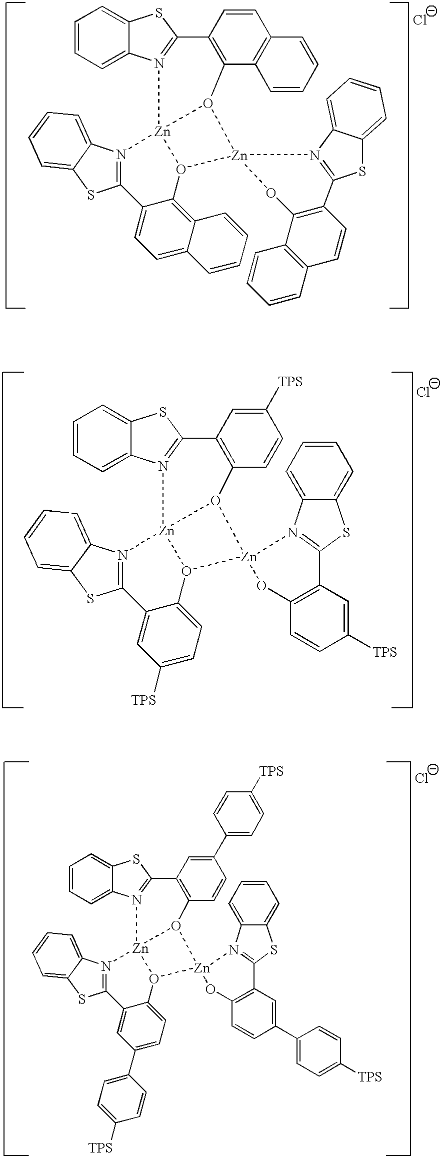

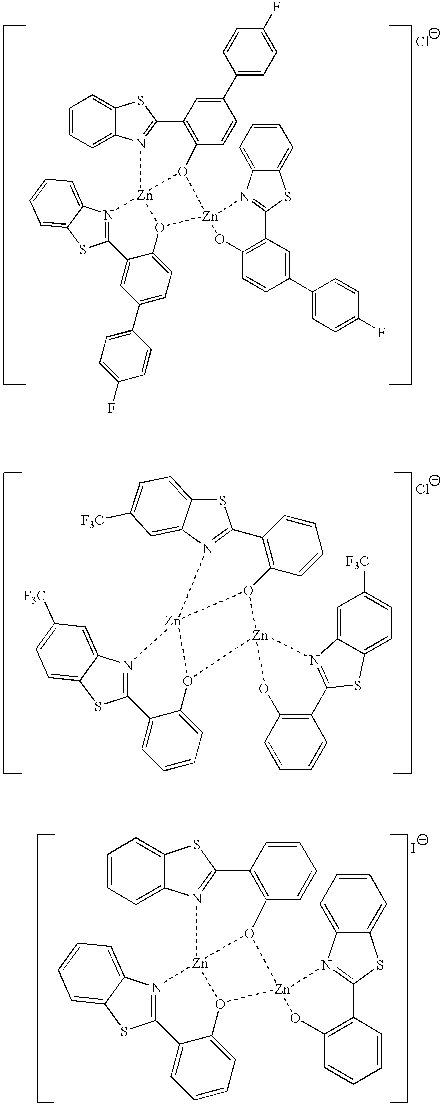

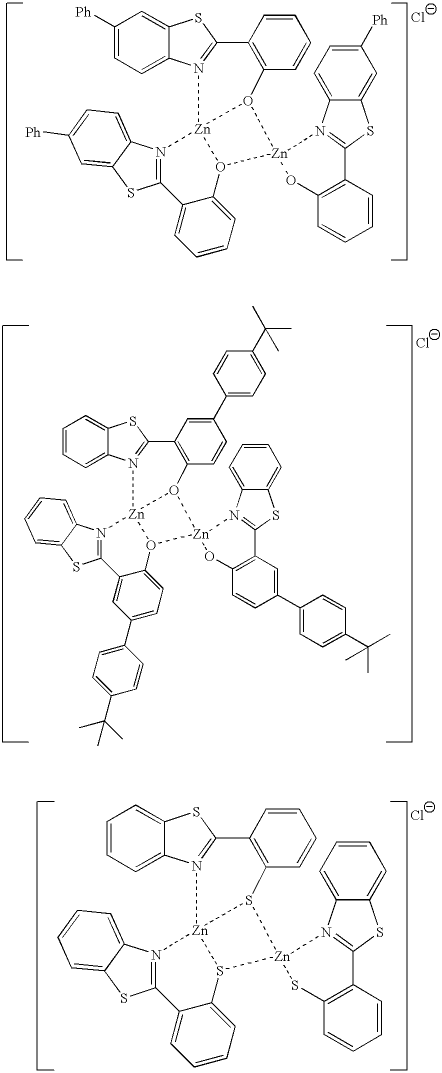

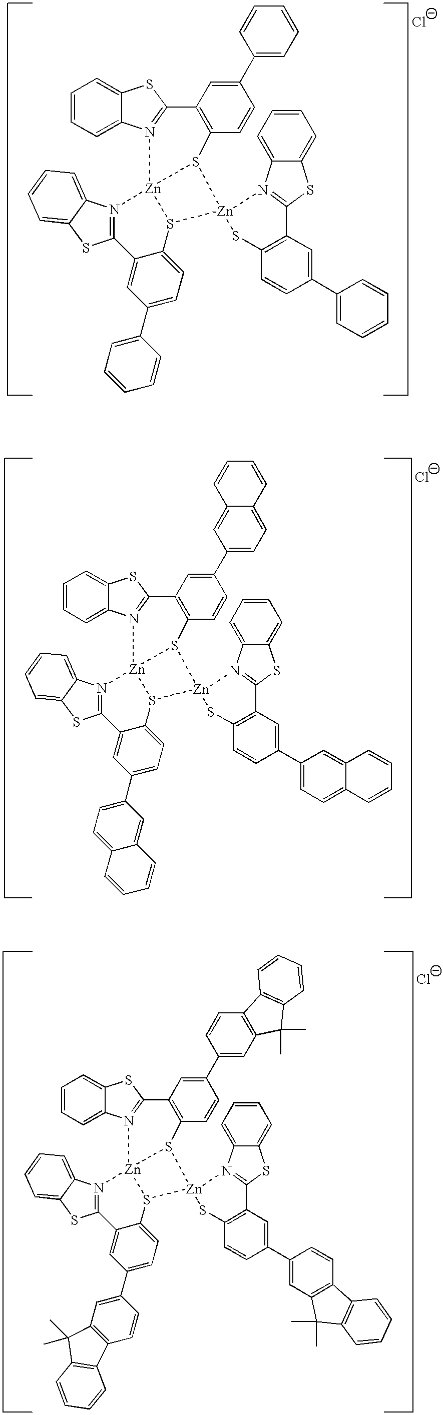

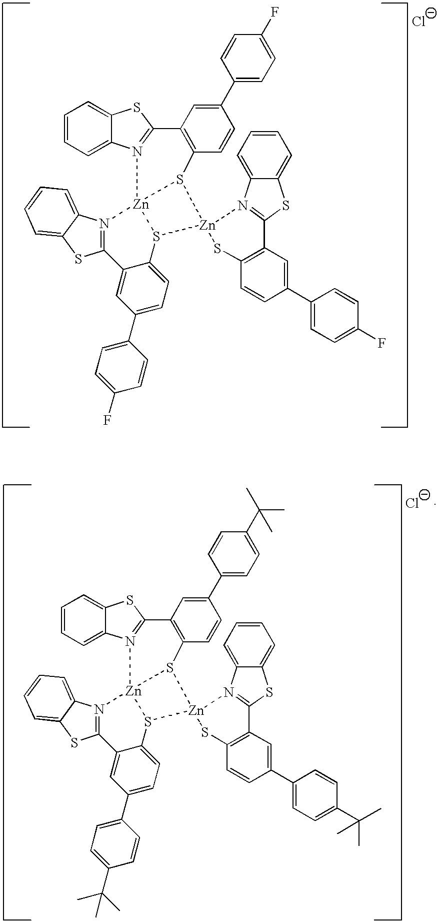

6. An electroluminescent compound according to claim 1, wherein Q is selected from Cl—, Br—, I—, CN—, ClO4-, CF3COO—, CF3SO3—, p-(CH3)PhSO3- and BF4-.

7. An electroluminescent device which comprises an electroluminescent compound according to any one of claims 1 to 6.

8. An electroluminescent device according to claim 7, wherein the compound is employed as the host material for electroluminescent layer.
